(19) United States
(12) Patent Application Publication
(10) Pub. No.: US 2025/0287162 A1
(43) Pub. Date: Sep. 11, 2025

(54) Hearing device comprising a mechanical element for sound transmission

(71) Applicant: SONOVA AG, Staefa (CH)

(72) Inventors: Fabio Schmidt, Uetikon am See (CH); Arno Römmeler, Zürich (CH); Erwin Kuipers, Staefa (CH); Andi Vonlanthen, Oberrohrdorf (CH)

(21) Appl. No.: 19/215,995

(22) Filed: May 22, 2025

Related U.S. Application Data
(63) Continuation-in-part of application No. 18/932,386, filed on Oct. 30, 2024.

(30) Foreign Application Priority Data
Dec. 20, 2023 (EP) 23218773.2

(51) Int. Cl. H04R 25/00

(52) U.S. Cl. CPC H04R 25/654; H04R 25/604; H04R 25/658; H04R 2225/0216

(57) ABSTRACT

The disclosure relates to a hearing device configured to be worn at an ear of a user, the hearing device including a sound delivery (SD) part configured to be at least partially inserted into an ear canal and having a custom shell at least partially customized to the ear canal and an electroacoustic transducer housed within the custom shell. The hearing device further includes a mechanical element connected to a medial end of the custom shell of the SD part, the mechanical element having a structure enclosing a cavity with an opening facing the SD part such that the cavity is acoustically coupled to the electroacoustic transducer. The structure includes a section in which thinner portions and thicker portions are alternatingly arranged around an axis of the structure.

### RELATED APPLICATIONS

The present application is a continuation-in-part of U.S. patent application Ser. No. 18/932,386, filed Oct. 30, 2024, which claims priority to EP Patent Application No. 23218773.2, filed Dec. 20, 2023, each of which is hereby incorporated by reference in its entirety.

### BACKGROUND INFORMATION

Hearing devices may be used to improve the hearing capability or communication capability of a user, for instance by compensating a hearing loss of a hearing-impaired user, in which case the hearing device is commonly referred to as a hearing instrument such as a hearing aid, or hearing prosthesis. A hearing device may also be used to output sound based on an audio signal which may be communicated by a wire or wirelessly to the hearing device. A hearing device may also be used to reproduce a sound in a user's ear canal detected by an input transducer such as a microphone or a microphone array. The reproduced sound may be amplified to account for a hearing loss, such as in a hearing instrument, or may be output without accounting for a hearing loss, for instance to provide for a faithful reproduction of detected ambient sound and/or to add audio features of an augmented reality in the reproduced ambient sound, such as in a hearable. A hearing device may also provide for a situational enhancement of an acoustic scene, e.g. beamforming and/or active noise cancelling (ANC), with or without amplification of the reproduced sound. A hearing device may also be implemented as a hearing protection device, such as an earplug, configured to protect the user's hearing. Different types of hearing devices configured to be be worn at an ear include earbuds, earphones, hearables, and hearing instruments such as receiver-in-the-canal (RIC) hearing aids, behind-the-ear (BTE) hearing aids, in-the-ear (ITE) hearing aids, invisible-in-the-canal (IIC) hearing aids, completely-in-the-canal (CIC) hearing aids, cochlear implant systems configured to provide electrical stimulation representative of audio content to a user, a bimodal hearing system configured to provide both amplification and electrical stimulation representative of audio content to a user, or any other suitable hearing prostheses. A hearing system comprising two hearing devices configured to be worn at different ears of the user is sometimes also referred to as a binaural hearing device. A hearing system may also comprise a hearing device, e.g., a single monaural hearing device or a binaural hearing device, and a user device, e.g., a smartphone and/or a smartwatch, communicatively coupled to the hearing device.

Typically, the gain of the sound amplified by a hearing device depends on frequency. Such a dependency is commonly referred to as the frequency response of the hearing device. The frequency response is a crucial parameter for listening experience, ensuring a high quality in sound reproduction, e.g., with regard to a naturalness, clarity, and consistency of the reproduced sound, and, in a hearing instrument, for allowing a good fitting of the sound amplification to an individual hearing loss. In particular, a broad bandwidth of the frequency response is often desirable. Further parameters affecting the audio quality include the number and position of resonances in the frequency response spectrum and the flatness of the frequency response curve. For instance, on the one hand, a rather flat frequency response can ensure that all frequencies are reproduced equally. On the other hand, a boosting or attenuating of certain frequencies or frequency ranges may be useful to implement targeted adjustments in the frequency output, e.g., to counteract imbalances or distortions.

The frequency response of a hearing device can be affected by many parameters including the properties of various components included in the hearing device, e.g., an amplifier, receiver, sound tube, filter, vent, ear canal sealing and/or the like, and the way these components are arranged and interact. Nevertheless, the choices in the design of a hearing device are also limited by size constrictions in order to be wearable at the ear, in particular to fit into an ear canal of a person. A further impact on the frequency response has the ear canal geometry itself which individually varies, at least to a certain extent. These constraints in the design of the hearing device may limit a desired frequency response behavior. It would therefore be desirable to provide for a means allowing to shape or tweak the frequency response governed by those constraints toward the more desired behavior.

Another problem of hearing devices which are at least partially worn inside an ear canal is that substances such as cerumen, liquids or dirt may enter a transducer, e.g. a receiver, or a sound tube connected to the transducer. Such an ingress may result in transducer malfunctioning and deterioration in hearing performance ranging from slightly distorted acoustic signals to a total failure of the transducer. Current solutions include so-called wax filters or cerumen filters preventing the substances from entering either by a more or less dense grid, or a membrane. One type of those transducer protection elements may be characterized as an acoustically open system allowing a transition of sound with rather small impact and/or acceptable changes of the sound output. Typical implementations comprise a fine and dense mesh that blocks cerumen, for instance at the medial side in front of a receiver. However, cerumen has a certain ability to stick to such a filter and cause partial or complete clogging of the filter. In case the level of clogging is too high, the hearing device wearer will perceive reduced and possibly distorted acoustic signals. This may require exchanging of the filter during which, however, the cerumen may be pushed even further inside.

Another type of transducer protectors may be characterized as acoustically closed which may be implemented, e.g., as a small flat membrane placed in front of the transducer. The use of such a small flat membrane has the disadvantage that, in particular at large sound levels, the membrane displacement is a nonlinear function of the acoustic pressure leading to nonlinearities in the reproduced sound in the ear canal. Another disadvantage is, because the membrane needs to be very compliant, that the membrane can easily get damaged or punctured. An alleviation of this issue would require an increase of the membrane's bending stiffness, e.g., by a thickening or changing the material properties, or of the membrane's pre-tension. Both aspects would lead to a substantial sound transmission loss. Such loss may be compensated by larger receivers which would, however, increase the size of the hearing device and thus result in a lower fit-rate of the hearing device into an ear canal.

US 2021/0258705 A1 discloses a transducer protection element including a dome implemented as a curved sound radiating part, a neck part for mounting the element to the transducer, and a suspension part formed between the dome and the neck part along a movement direction of the dome so as to provide for sound passage through the dome with little attenuation and distortion in a way that the protection element is acoustically transparent with regard to its impact on the transmitted sound. However, also with regard to unfavorable or improvable sound properties, the amplified sound can thus not be altered by its transmission through the protection element.

### BRIEF DESCRIPTION OF THE DRAWINGS

Reference will now be made in detail to embodiments, examples of which are illustrated in the accompanying drawings. The drawings illustrate various embodiments and are a part of the specification. The illustrated embodiments are merely examples and do not limit the scope of the disclosure. Throughout the drawings, identical or similar reference numbers designate identical or similar elements. In the drawings:

FIG. 1 schematically illustrates an exemplary hearing device including a SD part connected to a mechanical element;

FIG. 2 schematically illustrates another exemplary hearing device including a SD part connected to a mechanical element;

FIGS. 3A, 3B schematically illustrate arrangements in which a hearing device including a SD part is at least partially inserted into an ear canal, wherein a mechanical element is connected or disconnected;

FIGS. 4A-4D schematically illustrate another exemplary hearing devices including a SD part connected to a mechanical element

FIGS. 5A-5H schematically illustrate circumferences of a structure of a mechanical element;

FIGS. 6A-6D schematically illustrate mechanical elements;

FIGS. 7A, 7B schematically illustrate further mechanical elements;

FIGS. 8A-8D schematically illustrate another mechanical element;

FIGS. 9A-9D schematically illustrate another mechanical element;

FIGS. 10A, 10B schematically illustrate another mechanical element;

FIGS. 11A, 11B schematically illustrate another mechanical element;

FIGS. 12A-12C schematically illustrate further mechanical elements;

FIGS. 13A, 13B schematically illustrate a thinner portion of a structure of a mechanical element during sound transmission;

FIG. 14 illustrates an exemplary frequency response curve;

FIGS. 15A-15B schematically illustrate an exemplary hearing device including a SD part integral with a mechanical element;

FIGS. 16A-16B schematically illustrate another exemplary hearing device including a SD part integral with a mechanical element;

FIGS. 17A-17B schematically illustrate an exemplary mold for forming hearing devices;

FIG. 18 schematically illustrates another exemplary mold for forming hearing devices; and

FIG. 19 illustrates an exemplary method for forming hearing devices using a mold.

### DETAILED DESCRIPTION

Described herein are a hearing device comprising a sound delivery (SD) part configured to be at least partially inserted into an ear canal, and a mechanical element configured to be connected to the SD part, according to the preamble of claim 1.

It is a feature of the present disclosure to avoid at least one of the above mentioned disadvantages and to provide for a hearing device in which properties of the sound outputted by an SD part can be modified in a convenient and/or adaptable and/or cost-efficient and/or user-friendly manner, e.g., with regard to a frequency response and/or a pressure of the outputted sound. It is another feature to provide for a hearing device with reliable protection against an ingress of substances. It is a further feature to provide for a mechanical element included in the hearing device which can be designed for the altering of sound outputted by the sound emitter in a desired way, e.g., with regard to possible improvements of the outputted sound, and which is also adapted for ingress protection. It is yet another feature to provide for a hearing device with an improved acoustic performance and/or good ingress protection and/or favorable geometrical dimensions, in particular with regard to a smaller size of the hearing device and/or a reduced length of a sound tube included in the hearing device.

Accordingly, the present disclosure proposes a hearing device configured to be worn at an ear of a user, the hearing device comprising
a sound delivery (SD) part configured to be at least partially inserted into an ear canal, the SD part comprising a sound tube having an axis in which direction sound is propagating, wherein the sound tube is acoustically coupled to an electroacoustic transducer; and
a mechanical element configured to be connected to the SD part, the element comprising a structure enclosing a cavity with an opening facing the SD part when the element is connected to the SD part such that the cavity is acoustically coupled to the electroacoustic transducer, wherein the structure comprises a section in which thinner portions and thicker portions are alternatingly arranged around an axis of the structure, wherein the axis of the structure is aligned within 20° relative to the axis of the sound tube when the element is connected to the SD part.

Thus, by acoustically connecting the mechanical element to the SD part, the thinner portions provided at a circumference surrounding the axis of the structure can be employed to provide for a transmission of the emitted sound in an advantageous way. The thinner portions may more easily be stimulated to vibrate during sound transmission, e.g., with a smaller mechanical damping and/or a larger vibration amplitude, as compared to the thicker portions due to a smaller mass and/or stiffness of the thinner portions. Compared to flat membranes known in the art, a larger surface can be realized by the structure of the mechanical element, resulting in improved sound transmission. Further, a volume of the cavity enclosed by the structure can be selected to be small enough to influence the acoustical properties in a desired way. In addition, the thinner and thicker portions can be geometrically designed to modify a frequency response and/or a pressure of the outputted sound in a desired way. A required acoustic transmission performance may be achieved by the combination of several thinner portions, whereas the mechanical stability is provided by different, thicker portions. Moreover, the mechanical element can serve as a protector against an ingress of substances into apertures at the SD part, e.g., at the sound tube. In this way, a functionality of an earwax filter may be implemented. Replacing an earwax filter with the mechanical element can be exploited for a further advantage to reduce a required length of the SD part, e.g., a sound tube, in which such an earwax filter would be commonly integrated.

Subsequently, additional features of the hearing device are described. Each of those features can be provided solely or in combination with at least another feature.

In some implementations, the structure is configured so as to provide for, when the element is connected to the SD part, a frequency response of the hearing device differing from the frequency response when the element is disconnected from the SD part.

In some implementations, the structure is configured to provide for, when the element is connected to the SD part, an acoustic pressure inside the ear canal which is increased for at least one frequency comprised in a frequency range between 1 kHz and 10 kHz as compared to the acoustic pressure when the element is disconnected. In some implementations, the acoustic pressure is increased by at least 2 dB, e.g., at least 3 dB, or at least 4 dB, or at least 5 dB. In some implementations, the acoustic pressure is increased within a frequency bandwidth comprised in said frequency range, wherein the frequency bandwidth is at least 10 Hz, e.g., 50 Hz.

In some implementations, the structure is configured to provide for, when the element is connected to the SD part, an acoustic pressure inside the cavity exceeding an acoustic pressure outside the cavity inside ear canal. In some implementations, the acoustic pressure inside the cavity exceeds the acoustic pressure outside the cavity by at least 5 dB in a frequency range between 100 Hz and 10 kHz.

In some implementations, the structure is configured to provide for at least one resonance frequency which, when the element is connected to the SD part, is shifted in the frequency response of the hearing device as compared to when the element is disconnected. In some implementations, the resonance frequency is shifted by at least 50 Hz.

In some implementations, the resonance frequency, when the element is connected to the SD part, is between 2 kHz and 7 kHz.

In some implementations, the frequency response comprises two resonance frequencies in a frequency range, e.g., between 1 kHz and 10 kHz, in particular between 2 kHz and 9 kHz, when the element is disconnected, and three resonance frequencies in this frequency range when the element is connected.

In some implementations, the structure is configured to provide for a cutoff frequency of at least 8 kHz when the element is connected. The cutoff frequency may be defined as a frequency above which a sound pressure level (SPL), in particular an SPL measurable at the tympanic membrane, is reduced by 20 dB per octave.

In some implementations, the electroacoustic transducer comprises a balanced armature transducer and/or a moving coil driver.

In some implementations, the thinner portions and the thicker portions are alternatingly arranged around the axis of the structure such that a transmission of sound through the structure is more effective at the thinner portions and a rigidity of the structure is more enhanced by the thicker portions.

In some implementations, said section of the structure is provided such that a volume of the enclosed cavity is minimized and a circumference along which the thinner portions and thicker portions are alternatingly arranged, e.g., an outer surface of the circumference, is maximized.

In some implementations, the thinner portions constitute at least two third of a circumference of the structure around which the thinner portions and the thicker portions are alternatingly arranged.

In some implementations, the circumference of the structure comprises at least six thinner portions. In some implementations, the circumference of the structure comprises at least seven thinner portions. In some implementations, the circumference of the structure comprises at least eight thinner portions.

In some implementations, a natural frequency of at least two of the thinner portions differs. The natural frequency may also be denoted as the eigenfrequency. In some implementations, the natural frequencies differ by at least 10 Hz, e.g., at least 50 Hz. Each of the different natural frequencies may thus contribute to a resonance frequency of the hearing device when the mechanical element is connected to the SD part. E.g., an occurrence of a sharp resonance peak may thus be avoided. In some implementations, the different natural frequencies are selected such that they collectively provide for a single peak in a frequency response spectrum when the mechanical element is connected to the SD part.

In some implementations, each of the thicker portions is arranged between two of the thinner portions. In some implementations, each of the thicker portions is protruding at an inner and/or outer surface of the structure.

In some implementations, one or more of the thinner portions arranged around the axis of the structure, e.g., each of the thinner portions arranged around the axis of the structure, are provided as a portion of the structure not exceeding, i.e. falling below or being equal, a thickness limit. In some implementations, each of the thicker portions is a portion exceeding, i.e. not falling below and not being equal, the thickness limit. In some implementations, the thickness limit is selected as a value of 0.15 mm or smaller. In some implementations, the thickness limit is a value of 0.14 mm or smaller, e.g., 0.13 mm or smaller, 0.12 mm or smaller, 0.11 mm or smaller, 0.10 mm or smaller, 0.09 mm or smaller, 0.08 mm or smaller, 0.07 mm or smaller, 0.06 mm or smaller, 0.05 mm or smaller, 0.04 mm or smaller, 0.03 mm or smaller, 0.02 mm or smaller, or 0.01 mm or smaller. While a smaller value of the thickness limit may be desirable in some implementations, providing such a thickness limit, e.g., below 0.1 mm and/or below 0.05 mm, may be restricted, e.g., due to production constraints.

In some implementations, one or more of the thicker portions arranged around the axis of the structure, e.g., each of the thicker portions arranged around the axis of the structure, has a maximum thickness which is at least 0.03 mm larger than a maximum thickness of a thinner portion adjoining, e.g., bordering, the thicker portion. In some implementations, one or more of the thicker portions arranged around the axis of the structure has a maximum thickness which is at least 0.05 mm larger than a maximum thickness of a thinner portion adjoining the thicker portion. In particular, selecting the maximum thickness of the thicker portions relative to the maximum thickness of an adjoining thinner portion can allow to provide for a desired stability of the element.

To illustrate, in a specific example, one or one or more of the thicker portions arranged around the axis may have a maximum thickness of about 0.2 mm and one or one or more of the thinner portions arranged around the axis may have a maximum thickness of about 0.14 mm. In another example, one or one or more of the thicker portions arranged around the axis may have a maximum thickness of about 0.1 mm and one or one or more of the thinner portions arranged around the axis may have a maximum thickness of about 0.05 mm.

In some implementations, at least one of the thinner portions has a homogenous thickness. In some implementations, at least one of the thinner portions has a varying thickness. In some implementations, at least one of the thicker portions has a homogenous thickness. In some implementations, at least one of the thicker portions has a homogenous thickness.

In some implementations, a thickness of the structure progressively (e.g., continuously and/or gradually) decreases in one or more of the thicker portions toward one or more of the thinner portions.

In some implementations, at least one of the thinner portions has a flat outer and/or inner surface. In some implementations, at least one of the thinner portions has a curved outer and/or inner surface. In some implementations, the curvature of the at least one thinner portion is smaller than the curvature of a tangent curve, e.g., an elliptical or circular tangent curve, touching a cross section of the structure.

In some implementations, the structure has a cross section with edges joined at corners, wherein the corners are formed by at least part of the thicker portions and the edges comprise at least part of the thinner portions.

In some implementations, at least two of the thinner portions are angled relative to one another.

In some implementations, the thinner portions have a width between adjoining thicker portions, and the thicker portions have a width between adjoining thinner portions, wherein the width of at least one of the thinner portions exceeds the width of the adjoining thicker portions by at least a factor of two. In some implementations, the width of at least one of the thinner portions exceeds the width of the adjoining thicker portions by at least a factor of three.

In some implementations, the structure encloses a volume inside the ear canal between the SD part and the tympanic membrane.

In some implementations, the structure has a cross section approximating a polygon. In some implementations, the polygon is concave. In some implementations, the polygon is convex. In some implementations, the polygon has a star shape.

In some implementations, at least two of the thinner portions, in particular thinner portions neighbouring each other, span an angle of at most 120° at the circumference of the structure. In some implementations, at least two of the thinner portions span an angle of at most 90° at the circumference of the structure. In some implementations, at least two of the thinner portions span an angle of at most 60° at the circumference of the structure. In some implementations, at least two of the thinner portions span an angle of at most 50° at the circumference of the structure.

In some implementations, at least two of the thinner portions lead to a corner at the circumference of the structure, wherein at least one of the thicker portions is arranged at the corner.

In some implementations, the structure has a cross section with a plurality of projections extending in a radial direction, wherein each of the projections comprises at least two thinner portions. In some implementations, the structure has a cross section with a plurality of projections extending in a radial direction, wherein each of the projections comprises at least two thinner portions and a thicker portion arranged at a radially outer end of the projection. In some implementations, at least one of the projections has a shape of a jag and/or a lug and/or a ledge.

In some implementations, the structure has a cross section approximating a shape of a star. In some implementations, the star shape is defined as a plurality of circularly arranged radial projections.

In some implementations, the structure has a cross section touching an outer tangent curve of a larger radius at which at least two of the thicker portions are located and an inner tangent curve of a smaller radius at which at least two other of the thicker portions are located, wherein at least two of the thinner portions extend between the outer tangent curve and the inner tangent curve. In some implementations, the outer and/or inner tangent curve is elliptical, in particular circular.

In some implementations, the structure has a cross section delimited inside an elliptical curve at which at least two of the thicker portions are located, wherein an inner volume enclosed by the structure is smaller than an outer volume enclosed between the circumference of the structure and the elliptical curve.

In some implementations, the mechanical element further comprises a sealing member configured for sealing against an ear canal wall, wherein the sealing member is integrally formed with the element. In some implementations, the sealing member has a shape of a dome.

In some implementations, the thinner portions constitute a surface of the structure of at least 30 mm². In some implementations, the thinner portions constitute a surface of the structure, e.g. a portion of the outer surface of the structure, of at least 40 mm², in particular at least 50 mm². In this way, a sound transmission through the protective element may be effectively increased, in particular by exploiting the 3D shape of the structure.

In some implementations, the structure comprises a front wall opposing the opening. In some implementations, the front wall comprises a thicker portion and/or a thinner portion. In some implementations, the structure comprises a lateral wall extending between the front wall and the opening, wherein a circumference surrounding the cavity is formed by the lateral wall. In some implementations, at least one of the thicker portions and/or at least one of the thinner portions of the lateral wall leads to the front wall.

In some implementations, one or more of the thicker portions protrude from the thinner portions between which they or arranged on the outside and/or on the inside of the structure. In some implementations, at least two of the thicker portions are spaced from one another along the circumference of the structure by one of the thicker portion arranged between and/or at least two of the thicker portions are spaced from one another along the circumference of the structure by one of the thinner portions arranged between.

In some implementations, one or more stiffeners are formed by one or more of the thicker portions. To illustrate, by providing the one or more thicker portions such that each one extends between two or more of the thinner portions of the structure, a stiffness of the structure can be increased between the thinner portions due to the larger rigidity of thicker portion forming the stiffener in between. In this way, an overall stability of the structure can be enhanced. In some implementations, one or more of the stiffeners are rod-shaped. In some implementations, one or more of the stiffeners are provided as fins. The fins may serve for reinforcement and/or for increasing the total sound radiating surface area and/or to obtain certain acoustic-mechanical vibration modes.

In some implementations, at least two of the thinner portions are spaced from one another along the circumference of the structure by a thicker portion arranged in between and/or at least two of the thicker portions are spaced from one another along the circumference of the structure by a thinner portion arranged in between.

In some implementations, at least one of the thicker portions and/or at least one of the thinner portions extends along, e.g., in parallel, to the axis of the structure. In some implementations, the axis is surrounded by a circumference of the structure at which the thinner portions and the thicker portions are alternatingly arranged. E.g., the circumference may be defined as a perimeter extending along an outer surface of the lateral wall. In some implementations, the axis extends through the opening and/or the front wall. In some implementations, the axis extends in a direction in which the SD part is insertable into the ear canal.

In some implementations, the mechanical element is configured to be connected to the SD part at a side of the SD part facing an inner region of the ear canal, in particular the tympanic membrane, when the SD part is inserted into the ear canal. In some implementations, the opening of the cavity enclosed by the structure of the mechanical element faces away from the inner region of the ear canal.

In some implementations, the mechanical element comprises a connector section at which the element is connectable to the SD part. In some implementations, the connector section has a thickness larger than the thickness of the thinner portions. In some implementations, the connector section has a thickness larger than the thickness of the thicker portions arranged around the axis of the structure.

In some implementations, the element is formed by injection moulding. In some implementations, the element is formed by injection molding of liquid silicone rubber (LSR).

In some implementations, one or more reinforcement parts made out of a different material than the structure are arranged on the outside and/or on the inside of the structure. In some implementations, at least one reinforcement part is arranged within the cavity to internally support the structure.

In some implementations, the structure comprises at least two thinner portions which are angled relative to one another. In an embodiment, a direction in which one of the at least two thinner portions vibrates may thus be angled relative to a direction in which another one of the at least two thinner portions vibrates when sound is transmitted through the at least two thinner portions. To illustrate, a first virtual plane may be defined as a plane extending through a perimeter of one of the at least two thinner portions, and a second virtual plane may be defined as a plane extending through a perimeter of another one of the at least two thinner portions, wherein the first virtual plane and the second virtual plane are angled relative to one another. E.g., a normal vector of the first virtual plane may be angled relative to a normal vector of the second virtual plane.

In some implementations, one or more of the thinner portions have a planar shape. In some implementations, one or more of the thinner portions have a curved shape. In some implementations, one or more of the thicker portions protrude from at least two of the thinner portions at a region of the structure at which the at least two thinner portions are angled relative to one another, e.g., at a corner of the structure.

In some implementations, the lateral wall surrounds the cavity, e.g., along a circumference of the lateral wall. The lateral wall and/or the front wall may comprise an inner surface delimiting the cavity and an outer surface opposing the inner surface. In some implementations, the axis of the structure is an axis of the lateral wall, e.g., an axis surrounded by the lateral wall and/or an axis extending along the lateral wall in a longitudinal direction. In some implementations, the axis extends through the cavity surrounded by the lateral wall between the opening, in particular a center of the opening, and the front wall, in particular a center of the front wall.

In some implementations, the front wall comprises a thinner portion. In some implementations, the front wall comprises a thicker portion. In some implementations, the front wall is planar. In some implementations, the front wall is curved. In some implementations, the front wall is curved toward the cavity.

In some implementations, the lateral wall comprises a portion in which the lateral wall tapers toward the front end. In some implementations, the lateral wall comprises a portion in which a cross section of the lateral wall remains substantially constant, in particular along a direction of extension in parallel to a central axis.

In some implementations, the thinner portions are predominantly configured to provide for a transmission of sound. For instance, an area of the structure which is predominantly configured for sound transmission may be provided by one or more thinner portions at the lateral wall and/or by one or more thinner portions at the front wall. In some implementations, one or more of the thicker portions may also be configured for sound transmission, e.g., to a lesser extent than the thinner portions. A sound transmissible area of the structure may thus be provided by one or more thinner portions and/one or more thicker portions.

In some implementations, the lateral wall comprises one or more of the thinner portions from which one or more of the thicker portions protrude at an outer surface and/or at an inner surface of the lateral wall. E.g., one or more of the thicker portions may protrude from the thinner portions at a corner region of the lateral wall at which the thinner portions are angled relative to one another and/or one or more of thicker portions may protrude from the thinner portions at a continuous region of the lateral wall at which the thinner portions are continuously joined.

In some implementations, at least one of the thinner portions of the lateral wall has a different thickness as compared to the thickness of at least one of the thinner portions of the front wall. In some implementations, at least one of the thinner portions of the lateral wall and at least one of the thinner portions of the front wall have an equal thickness.

In some implementations, a thicker portion leading to the opening may be configured to provide for an attachment of the element to the transducer or sound tube. To illustrate, the rigidity of the structure may be enhanced at the opening by the thicker portion leading to the opening such that a stable attachment can be achieved, e.g., without risking damaging of the structure. In some implementations, the thicker portion leading to the opening extends around a circumference of the lateral wall. In particular, when the thicker portion leading to the opening extends around a circumference of the lateral wall, a uniform stability of the attachment and/or a minimum risk of damaging the structure may be realized.

In some implementations, one or more of the stiffeners are formed by one or more of the thicker portions of the lateral wall. To illustrate, one or more thicker portions at the lateral wall may constitute stiffeners, in particular to stabilize the lateral wall with regard to a lower stability of the one or more of the thinner portions at the lateral wall as compared to the thicker portions.

In some implementations, one or more of the stiffeners are formed such that the structure is configured to contact an ear canal wall at the stiffeners when connected to the electroacoustic transducer or sound tube, and when inserted into an ear canal. The stiffeners may thus provide a spacing of the one or more thinner portions at the lateral wall from the surrounding environment, e.g., the ear canal wall, in particular to ensure that vibrations of the thinner portions, e.g., during a sound transmission, are not hindered by the surrounding environment.

In some implementations, the structure has a cross section approximating a polygon with edges joined at corners, wherein the corners are formed by at least part of the thicker portions, e.g., the stiffeners, and the edges comprise at least part of the thinner portions. E.g., the edges may be formed by at least part of the thinner portions and/or the edges may comprise at least one thicker portion in addition to one or more thinner portions. In some implementations, the polygon is equilateral such that the edges have an equal length. In some implementations, the polygon is equiangular such that the angles at the corners are equal. In some implementations, the angles at two or more of the corners are different. In some implementations, one or more of the edges are curved. In an embodiment, one or more of the edges are planar.

In some implementations, at least one reinforcement part made out of a different material than the structure is arranged within the cavity to internally support the structure. In some implementations, the reinforcement part is arranged within the cavity to internally support the structure at a position of one or more of the thicker portions. In an embodiment, the reinforcement part is configured as a structure extending between two supported thicker portions. In some implementations, the reinforcement part has a planar structure. In an embodiment, the reinforcement part has a rectangular shape. In some implementations, the reinforcement part is provided with a cut out facing the front wall and/or a cut out facing the opening. E.g., the cut out may be a circular sector cut out.

In some implementations, the structure is made of a single material or multiple materials, e.g. silicone rubber and/or another polymer with Young's modulus less than 10 MPa, in particular less than 5 MPa, e.g., less than 3 MPa, and/or being provided with a coating repellent to cerumen.

In some implementations, a length of the thinner portions of the structure is at least 2 mm and/or at most 10 mm. In some implementations, a diameter of the structure, in particular of the front wall, is at most 7 mm. In some implementations, a thickness of at least one of the thinner portions is 0.05 mm or below, at least for the thinnest parts.

In some implementations, the element further comprises at least one dome configured for sealing against an ear canal, wherein the at least one dome is integrally formed with the element.

In some implementations, the structure comprises rounded edges between the thinner portions to avoid irritation or wearing comfort issues when a transducer element with the protection system is worn in the ear, wherein the radius of the rounded edges may be less than 0.5 mm but greater than 0.05 mm. In some implementations, the rounded edges are provided as thicker portions.

In some implementations, an earpiece and/or an ITE part may comprise the SD part and the mechanical element. The earpiece and/or an ITE part may be configured for at least partial insertion into the ear canal. The SD part may comprise a shell customized to a shape of an individual ear canal of the user. As another example, the SD part may comprise a flexible member, e.g., a dome, which can conform its shape to the shape of the individual ear canal. In some implementations, the electroacoustic transducer is included in the SD part. In some implementations, the hearing device comprises a housing configured to be worn behind an ear of a user. In some implementations, the electroacoustic transducer is included in the housing configured to be worn behind the ear.

In some implementations, the element comprises one or more recesses arranged along an inner surface of the element, wherein the one or more recesses are configured to engage a corresponding number of protrusions on an outer surface of the SD part. In this way, the element may be connectable to the SD part. E.g., the recess and the protrusion may be ring-shaped. E.g., the protrusion may extend around an outer circumference of the electroacoustic transducer or the sound tube. E.g., the element may comprise a connector section comprising the recess.

In some implementations, the element may be connectable to the SD part by means of screwing and/or clamping. This may allow for exchanging the protective element by the user.

In some implementations, the shape of the structure may be such that the corners of the structure protect the thinner portions to be in contact with the ear canal wall so that their vibration is not hindered.

In some implementations, the element may comprise a 2K overmolded part, in particular having a hard core and a softer portion, wherein the core may serve for pressure equalization.

Different types of a hearing device can be distinguished by a position at which they are worn at the ear. Some hearing devices, such as behind-the-ear (BTE) hearing aids and receiver-in-the-canal (RIC) hearing aids, typically comprise an earpiece configured to be at least partially inserted into an ear canal of the ear, and an additional housing configured to be worn at a wearing position outside the ear canal, in particular behind the ear of the user. Some other hearing devices, as for instance earbuds, earphones, hearables, earplugs, in-the-ear (ITE) hearing aids, invisible-in-the-canal (IIC) hearing aids, and completely-in-the-canal (CIC) hearing aids, commonly comprise such an earpiece to be worn at least partially inside the ear canal without an additional housing for wearing at the different ear position.

FIG. 1 illustrates an exemplary hearing device 10 according to some embodiments of the present disclosure. The present embodiments aim at providing sound transmission through a mechanical element 12 that can be connected to a sound delivery (SD) part 20 of hearing device 10 comprising a sound tube 16. The SD part 20 may include an electroacoustic transducer and/or sound tube 16 may be acoustically coupled to an electroacoustic transducer external from SD part 20. Mechanical element 12 may have a hollow shape with a cavity enclosed by a structure 18. In some examples, the cavity may be entirely closed but for an opening 8 through which the cavity is acoustically coupled to the electroacoustic transducer when element 12 is connected to SD part 20. The mechanical element 12 can fulfill multiple purposes including a modifying of a frequency response of hearing device 10 and/or providing a thorough barrier against any substances or fluids that can be present in an ear canal of a user.

In the example illustrated in FIG. 1, hearing device 10 is implemented as a RIC hearing aid. RIC hearing aid 10 comprises a BTE part 21 configured to be worn at an ear at a wearing position behind the ear, and ITE part 11 configured to be worn at the ear at a wearing position at least partially inside an ear canal of the ear. Hearing device 10 further comprises mechanical element 12 connectable to ITE part 11.

ITE part 11 is implemented as an earpiece at least partially insertable into an ear canal. ITE part 11 comprises SD part 20. SD part 20 comprises an electroacoustic transducer 17 including a housing 14 accommodating electrical components 13. In the illustrated example, electroacoustic transducer 17 is implemented as a receiver or loudspeaker, wherein electrical components 13 are configured to convert an electrical signal into sound. In particular, electroacoustic transducer 17 may be implemented as a balanced armature transducer. In other examples, electroacoustic transducer 17 may be implemented as a moving coil speaker. In still other examples, electroacoustic transducer 17 may implemented as a microphone, e.g. an ear-canal microphone, wherein components 13 may be configured to convert sound into an electrical signal. Housing 14 is further provided with a sound tube 16 for emitting the sound generated by components 13 toward an inner region of the ear canal. Electroacoustic transducer 17 can thus be acoustically coupled to an inner region of the ear canal when SD part 20 is at least partially inserted into the ear canal in order to emit sound into the inner region of the ear canal toward the tympanic membrane. SD part 20 may include additional components as may serve a particular implementation, e.g., an ear canal microphone, a physiological sensor, a processor, and/or the like, which may be accommodated in housing 14.

ITE part 11 further comprises a sealing member 15 adapted to contact an ear canal wall when ITE part 11 is at least partially inserted into the ear canal. In the illustrated example, sealing member 15 is provided at SD part 20. In other examples, sealing member 15 may be integrally formed with mechanical element 12. Sealing member 15 is implemented as a flexible member configured to conform to the shape of the ear canal wall. For instance, the flexible member may have a shape of a dome. In other examples, sealing member 15 may be provided as a shell having a shape customized to an individual ear canal.

ITE part 11 further comprises mechanical element 12. Mechanical element 12 is configured to be mechanically connected to SD part 20. When connected, as illustrated in FIG. 1, mechanical element 12 can be inserted into the ear canal along with SD part 20. Mechanical element 12 comprises structure 18 enclosing a cavity with opening 19 facing the SD part 20. Thus, element 12 can be configured to be acoustically coupled to electroacoustic transducer 17 via opening 19 facing the SD part 20. In some implementations, as illustrated, mechanical element 12 is connected to electroacoustic transducer 17, e.g., at transducer housing 14. For instance, when mechanical element 12 is connected to electroacoustic transducer 17, sound tube 16 may be received by element 12 through opening 19 in order to provide for the acoustical coupling to electroacoustic transducer 17. In other examples, mechanical element 12 may be connected to at least another part and/or another component of SD part 20, e.g., to sealing member 15, in a way that element 12 is acoustically coupled to electroacoustic transducer 17 through opening 19.

BTE part 21 comprises a BTE housing 24 configured to be worn behind the ear. BTE part 21 and ITE part 11 are interconnected by a cable 22. A processor 26 accommodated in BTE housing 24 is communicatively coupled to electroacoustic transducer 17 via cable 19 and a cable connector 29 provided at BTE housing 24. Processor 26 can thus be configured to provide an audio signal to electroacoustic transducer 17 based on which the sound is generated. In the illustrated example, processor 26 is further operatively connected to an electroacoustic transducer 27 configured to convert sound into an electrical signal, which may be implemented by a microphone and/or a microphone array, and a user interface 28, for instance a switch. BTE part 21 further includes a battery 23 as a power source for the above described components.

In some other examples, a hearing device may be implemented as BTE hearing aid. A BTE part of the BTE hearing aid may correspond to BTE part 21 described above, wherein the BTE part of the BTE hearing aid further comprises electroacoustic transducer 17 for converting an electrical signal into sound. An SD part of the BTE hearing aid may comprise a sound tube through which the sound generated by electroacoustic transducer 17 can be delivered into the ear canal. An ITE part of the BTE hearing aid may thus comprise mechanical element 12 connected to such an SD part. When mechanical element 12 is connected to the SD part of the BTE hearing aid, mechanical element 12 can thus be acoustically coupled to electroacoustic transducer 17 via the sound tube. For instance, mechanical element 12 may be connected to the sound tube such that a sound outlet of the sound tube may be received by element 12 through opening 19 in order to provide for the acoustical coupling to electroacoustic transducer 17. In other examples, mechanical element 12 may be connected to at least another part and/or another component of the SD part of the BTE hearing aid.

In some other examples, a hearing device may be implemented as an ITE hearing aid, an IIC hearing aid, a CIC hearing aid, or earbud, which may consist of an ITE part or earpiece configured to be at least partially inserted into an ear canal and mechanical element 12. The ITE part may then comprise, in addition to the components of ITE part 11 described above, one or more of the components of BTE part 21 described above.

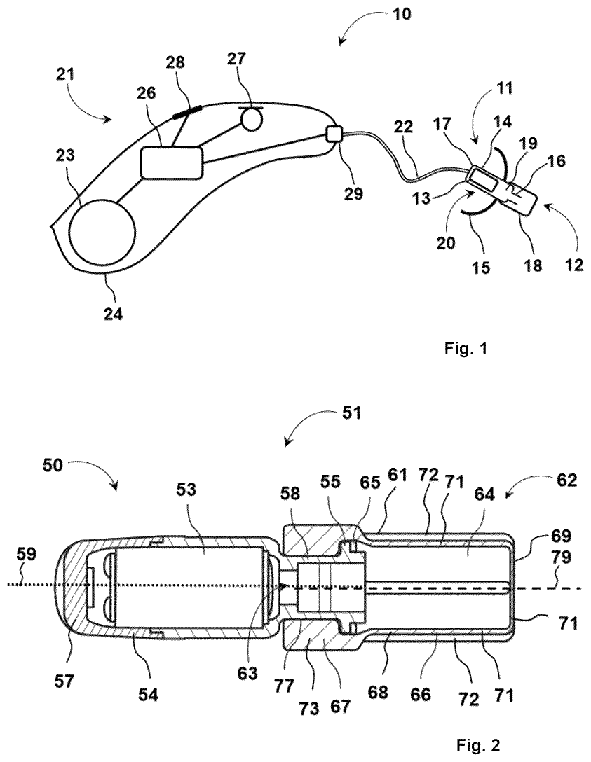

FIG. 2 illustrates an exemplary ITE part 51 comprising an SD part 50 and a mechanical element 62 of a hearing device according to some embodiments of the present disclosure. The hearing device may consist of ITE part 51, or may comprise further components such as a BTE part. E.g., a RIC hearing aid may comprise ITE part 51 and a BTE part. SD part 50 comprises an electroacoustic transducer 57 implemented as a receiver. Receiver 57 comprises a housing 54 accommodating electrical components 53. A sound outlet of receiver 57 is provided as a sound tube 58 formed in housing 54. Sound tube 58 is implemented as a spout extending in a medial direction, in particular toward the tympanic membrane, when ITE part 51 is at least partially inserted into the ear canal. Sound tube 58 has an axis 59 in which direction sound generated by electroacoustic transducer 57 is propagating. Axis 59 extends in a longitudinal direction of sound tube 58. Axis 59 extends through a center of sound tube 58 and may also be referred to as a central axis.

Mechanical element 62 can be connected to SD part 50. In some implementations, mechanical element 62 can be mounted to electroacoustic transducer 57, e.g., sound tube 58 and/or another portion of housing 54. For instance, the mounting may be achieved by a recess 65, e.g. a circular recess 65, along an inner surface of mechanical element 62 which engages with a corresponding protrusion 55, e.g. a ring-shaped protrusion 55, on an outer circumference of sound tube 58.

Mechanical element 62 comprises a structure 61 enclosing a cavity 64 with an opening 63. When mechanical element 62 is connected to SD part 50, opening 63 faces SD part 50 such that cavity 64 is acoustically coupled to electroacoustic transducer 57. In some implementations, as illustrated, electroacoustic transducer 57 and/or sound tube 58 may extend into cavity 64 through opening 63. A portion of electroacoustic transducer 57 and/or sound tube 58 extending into cavity 67 may constitute a reinforcement part to internally support structure 61. In other implementations, electroacoustic transducer 57 and/or sound tube 58 may be provided external from cavity 64 at a distance from opening 63.

Structure 61 comprises a front wall 69 at a front end opposing a rear end at which opening 63 is provided, and a lateral wall 68 extending between front wall 69 and opening 63. Lateral wall 68 surrounds cavity 64. The front end is a medial end, i.e., front wall 69 faces the tympanic membrane inside the ear canal when ITE part 51 is at least partially inserted. The rear end is a lateral end such that opening 63 faces the ear canal entrance.

Structure 61 comprises a first section 66 extending between a front end of sound tube 58 and the front end of structure 61. First section 66 comprises front wall 69 and a portion of lateral wall 68 leading to front wall 69. The portion of lateral wall 68 comprised in first section 66 surrounds a volume portion of cavity 64 which remains hollow, in particular empty, when mechanical element 62 is connected to SD part 50. First section 66 comprises thinner portions 71 and thicker portions 72 alternatingly arranged around an axis 79 of structure 61. Axis 79 extends in a longitudinal direction of first section 66 of structure 61, in particular along lateral wall 68, and may also be referred to as a longitudinal axis. In the illustrated example, axis 79 extends through a center of first section 66 and may also be referred to as a central axis. When mechanical element 62 is connected to SD part 50, axis 79 of structure 61 is aligned within 20°, e.g., 10°, relative to axis 59 of sound tube 58. An angle enclosed between axis 79 of structure 61 and axis 59 of sound tube 58 may thus not exceed 20°. In the illustrated example, axis 79 of structure 61 is substantially overlapping and/or concentric with axis 59 of sound tube 58. In other examples, axis 79 of structure 61 may be positioned at a distance from axis 59 of sound tube 58, e.g., shifted in parallel to axis 59 of sound tube 58.

Thinner portions 71 and thicker portions 72 alternatingly arranged alternatingly arranged around a circumference of structure 61, in particular around a circumference of lateral wall 68. In particular, each of thicker portions 72 may be arranged between two of thinner portions 71. Neighbouring thinner portions 71 may thus be circumferentially spaced by thicker portion 72 arranged in between. In some implementations, thinner portions 71 and thicker portions 72 extend in a longitudinal direction in parallel to axis 79 of structure 61. In particular, central axis 79 may be surrounded by the portion of lateral wall 68 comprised in first section 66. In some implementations, thinner portions 71 and/or thicker portions 72 lead to front wall 69. In some implementations, as illustrated, front wall 69 is a thinner portion 71. On other implementations, front wall 69 may be implemented as a thicker portion 72.

First section 66 of structure 61 can be exploited to transmit sound emitted by electroacoustic transducer 57 from cavity 64 to an exterior of structure 61, in particular an inner region of the ear canal when inserted into the ear canal. First section 66 may thus also be denoted as a membrane or a membrane section. In particular, a transmission of sound through structure 61 can be more effective at thinner portions 71 and a rigidity of structure 61 can be enhanced by thicker portions 61. To illustrate, thinner portions 71 may be predominantly employed to transmit sound and thicker portions 72 may predominantly provide for a different functionality, e.g., stabilizing structure 61 and/or maintaining a desired shape of mechanical element 62 also during sound transmission. In particular, thinner portions 71 may more easily be stimulated to vibrate during sound transmission, e.g., with a smaller mechanical damping and/or a larger vibration amplitude, as compared to thicker portions 7.2 due to a smaller mass of the thinner portions 71.

Compared to flat membranes known in the art, a much larger surface can be realized by structure 61, resulting in improved sound transmission. A further advantage of embodiments described herein is the possibility to adapt the geometry of the acoustically active elements of structure 61. For example, a frequency response of the hearing device may be altered according to particular specifications and/or an acoustic pressure inside the ear canal may be increased in a particular frequency range and/or at least one resonance frequency may be shifted and/or added in the frequency response and/or a resonance peak may be broadened and/or a cutoff frequency may be altered and/or an improved acoustic signal output may be provided in a certain frequency band. The geometry membrane section 66 may be optimized to match a desired acoustic performance. In some implementations, a mesh or a foam with open cells may be further included inside cavity 64 to enhance the performance.

Structure 61 comprises a second section 67 comprising a portion of lateral wall 68 extending between opening 63 and the front end of sound tube 58. The portion of lateral wall 68 comprised in second section 67 surrounds a volume portion of cavity 64 which is filled by a portion of SD part 50 when element 62 is connected to SD part 50. Second section 67 comprises a thicker portion 73 providing for a sufficient robustness for mounting mechanical element 62 to SD part 50, in particular electroacoustic transducer 57. Second section 67 may thus also be denoted as a connector or a mounting section. Thicker portion 73 may be denoted as a connector or mounting portion. Thicker portion 73 may extend around a circumference of second section 67, e.g., with a homogenous thickness. In some implementations, thicker portion 73 may be provided with a larger thickness as compared to thicker portions 72 included in first section 66. An inner surface 77 of thicker portion 73 delimiting cavity 64 at opening 63 may have a shape corresponding to the shape of the portion of electroacoustic transducer 57 and/or sound tube 58. Protrusion 55 may be formed in second section 67.

Mechanical element 62 may be adapted for different ear canal geometries, e.g. small or large ear canals or circular and elliptical ones. In some implementations, mechanical element 62 can be combined together with a sealing member, e.g., a dome, into one single element. In particular, mechanical element 62 may provide for a mechanical coupling to electroacoustic transducer 57, e.g., sound tube 58 and/or another portion of housing 54, as it is implemented with prior art domes.

By choosing an appropriate material, e.g., silicone rubber, of mechanical element 62 and/or by applying a coating, an adhesion of cerumen to a surface of mechanical element 62 can be reduce such that a cleaning of mechanical element 62 can be minimized. Further, due to a smooth surface, it is much easier to clean a mechanical element 62 with a smooth surface than a puncture-sensitive membrane. In some implementations, a material of mechanical element 62 is selected to be biocompatible due to a potential contact with skin. An increased reliability of mechanical element 62 may reduce the need for transducer servicing and less spare parts, e.g. wax filters, may be needed.

In an illustrative example, an effective length of structure 61, in particular of thinner portions 71 provided in membrane section 66, may be 2 mm to 10 mm, e.g. about 5 mm. A diameter of structure 61, in particular of membrane section 66, may be 1 mm to 7 mm. A thickness of thinner portions 71 in membrane section 66 may be less than 0.15 mm. For instance, thinner portions 71 may at least partially provided with a thickness of 0.05 mm or below, e.g., 0.02 mm for the thinnest regions. Improvements in a processing of liquid silicone rubbers in the recent years opened the possibility to create parts with membranes as thin as required for the present application, yet stable enough to sustain the mechanical loads.

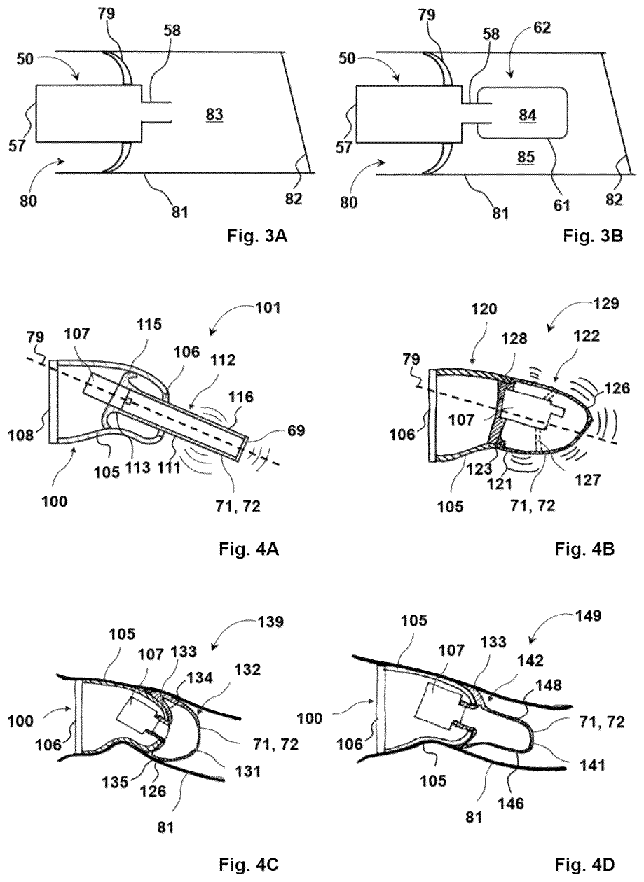

FIGS. 3A and 3B schematically illustrate an arrangement in which ITE part 51 is at least partially inserted into an ear canal 80. Ear canal 80 is delimited by an ear canal wall 81 leading toward a tympanic membrane 82. ITE part 51 further comprises a sealing member 79 configured to provide for an acoustical seal against ear canal wall 81. For instance, sealing member 79 may be implemented as a flexible member, as illustrated, e.g., a dome, or a custom shell. In the illustrated example, sealing member 79 is included in SD part 50. E.g., sealing member 79 may be attached to electroacoustic transducer 57, in particular at spout 58 and/or at another part of the transducer housing. In other examples, sealing member 79 may be integrally formed with mechanical element 62. An acoustical seal with the ear canal wall may thus be provided at a portion of ITE part 51 contacting the ear canal wall. The acoustical seal may at least partially block ambient sound from entering the inner region of ear canal 80 and/or the sound waves generated by electroacoustic transducer 57 from entering an ambient environment outside ear canal 80. An inner region of ear canal 80 may be defined as a region between tympanic membrane 82 and ITE part 51 up to a position at ear canal wall 81 at which the acoustical seal by sealing member 79 is provided, when ITE part 51 is at least partially inserted into ear canal 80.

In a first arrangement illustrated in FIG. 3A, only SD part 50, from which mechanical element 62 is disconnected, is inserted into ear canal 80. The inner region of ear canal 80 has a volume 83. Volume 83 may be denoted as an ear canal volume.

In a second arrangement illustrated in FIG. 3B, SD part 50 and mechanical element 62 connected to SD part 50 is inserted into ear canal 80. Mechanical element 62 comprises structure 61 enclosing cavity 64, in particular an empty portion of cavity 64, having a volume 84 extending in front of spout 84. Volume 84 may thus be denoted as an extended spout volume. Accordingly, in the second arrangement, the inner region of ear canal 80 has a volume 85 which, when compared to volume 83 in the first arrangement, is reduced by extended spout volume 84. Volume 85 may thus be denoted as a residual ear canal volume. As a result, structure 61 of mechanical element 62 divides ear canal volume 83 into two separate volumes, the extended spout volume 84 and the residual ear canal volume 85.

Designing mechanical element 62 comprising structure 61 in a way as described above and below can provide for an acoustic pressure inside extended spout volume 84 exceeding an acoustic pressure within residual ear canal volume 85. To this end, structure 61 may be provided such that volume 84 of the enclosed cavity is minimized and a circumference along which the thinner portions and thicker portions are alternatingly arranged is maximized. Structure 61 can thus be configured to provide for, when element 62 is connected to the SD part, an acoustic pressure inside the cavity enclosed by structure 61 which is exceeding an acoustic pressure outside the cavity inside ear canal.

FIGS. 4A-4D schematically illustrate further exemplary ITE parts 101, 129, 139, 149 comprising an SD part 100, 120 and a mechanical element 112, 122, 132, 142 of a hearing device according to some embodiments of the present disclosure. SD part 100, 120 comprises a custom shell 105 having a shape at least partially customized to ear canal 80, in particular to the ear-canal of an individual user. Custom shell 105 can thus constitute a sealing member forming an acoustical seal with ear canal wall 81. To fabricate custom shell 105, a user-specific ear canal geometry may be initially determined, e.g., by taking impressions of the user's ear canal. Subsequently, shell 105 can be formed from a resin by taking into account the predetermined individual ear canal geometry, e.g., in a resin based 3D printing technology, such as digital light processing (DLP) or another stereolithography (SLA) process. As illustrated, custom shell 105 may be open at a rear end, which may also be referred to as a lateral end. The opening may also be referred to as a lateral opening. The opening may be covered by a faceplate 108 mountable to the rear end.

SD part 100 further comprises an electroacoustic transducer 107 accommodated in an inner volume enclosed by custom shell 105. Electroacoustic transducer 107 is implemented as a receiver. Custom shell 105 further comprises an opening 106 at a front end, which may also be referred to as a medial end. Opening 106 may also be referred to as a medial opening. Medial opening 106 is intended to provide for a functionality to deliver sound generated by electroacoustic transducer 107 into ear canal 80, in particular into inner region 83, 85.

In the embodiment illustrated in FIG. 4A, mechanical element 112 is connected to electroacoustic transducer 107 such that it extends from the inner volume enclosed by custom shell 105 through medial opening 106 to the outer volume surrounding custom shell 105. When ITE part 101 is at least partially inserted into ear canal 80, mechanical element 112 thus extends into inner region 83, 85. Mechanical element 112 has a structure 111 including a first section 116 comprising thinner portions 71 and thicker portions 72 alternatingly arranged around axis 79 of structure 111. Structure 111 includes a second section 113 at which structure 111 is mounted to electroacoustic transducer 107. Second section 113 is provided with a circumferential projection 115, e.g., at a rear end of structure 111. Circumferential projection 115 contacts an inner surface of custom shell 105. E.g., circumferential projection 115 may be elastic to conform to the inner surface. Circumferential projection 115 may provide for an acoustical seal inside the inner volume of custom shell 105 and/or a fixation of mechanical element 112 relative to electroacoustic transducer 107 and/or a fixation electroacoustic transducer 107 inside shell 105. Thus, mechanical element 112 may provide for sound transmission through thinner portions 71 included in first section 116 which may be located in the inner volume of custom shell 105 and/or outside the inner volume. In the illustrated example, medial opening 106 of shell 105 is significantly wider than mechanical element 112. Thus, mechanical element 112 may provide for sound transmission through thinner portions 71 included in first section 116 which may be located in the inner volume of custom shell 105 and/or outside the inner volume.

In the embodiment illustrated in FIG. 4B, ITE part 129 comprises a mechanical element 122 which is connected to custom shell 105 of an SD part 120, e.g., at the position of medial opening 106. In this way, the cavity enclosed by a structure 121 of mechanical element 122 can be acoustically coupled to electroacoustic transducer 107 through the opening of the cavity when mechanical element 122 is connected to custom shell 105. E.g., a click-on interface may be provided to releasably attach and/or detach mechanical element 122 to custom shell 105. As illustrated, structure 121 comprises a first section 126 in which thinner portions 71 and thicker portions 72 are alternatingly arranged around axis 79 of structure 121. In the example, first section 126 of structure 121 has a dome shape, as compared to a cylindrical shape of first section 116 of structure 111 illustrated in FIG. 4A. Structure 121 includes, in addition to first section 126, a second section 123. Second section 123 comprises a retention structure 128. Retention structure 128 may provide for a retention of mechanical element 122 inside custom shell 105 and/or may also provide for a fixation of electroacoustic transducer 107. Retention structure 128 is at least partially arranged in the inner volume enclosed by custom shell 105, e.g., at a position close to medial opening 106. As illustrated, the sound port of electroacoustic transducer 107 may then be arranged outside the inner volume enclosed by custom shell 105 inside the cavity enclosed by structure 121. E.g., electroacoustic transducer 107 may extend through medial opening 106 or may be arranged in front of medial opening 106, e.g., at the medial side of shell 105. In some implementations, a support structure 127 may be arranged within first section 126 and/or second section 123 to suspend electroacoustic transducer 107.

In the embodiment illustrated in FIG. 4C, ITE part 139 comprises mechanical element 132 with a structure 131 including, in addition to first section 126, a second section 133. Second section 133 comprises a first portion 134 by which mechanical element 132 is connected to electroacoustic transducer 107. First portion 134 has an opening leading to a cavity enclosed by structure 131 such that the cavity is acoustically coupled to electroacoustic transducer 107. Second section 133 comprises a second portion 135 by which mechanical element 132 is connected to custom shell 105 of an SD part 100, e.g., at an outer surface of shell 105, for instance by a click-on connection. As illustrated, second portion 135 may extend at least partially around first portion 134. The cavity enclosed by structure 131 may extend in between the first and second portion 134, 135. In the illustrated example, second portion 135 at least partially contacts ear canal wall 81. In this way, in acoustic seal of ITE part 139 may be enhanced.

ITE part 149 illustrated in FIG. 4D substantially corresponds to ITE part 139 shown in FIG. 4C, with the exception that a mechanical element 142 comprises a structure 141 having a first section 146 in which thinner portions 71 and thicker portions 72 are alternatingly arranged around axis 79 of structure 111, wherein first section 146 comprises a cylindrically shaped part 148. In this way, first section 146 can be more radially spaced from the ear canal wall 81 as compared to dome shaped first section 126 illustrated in FIG. 4C. A radial sound transmission through first section 146 into ear canal 80 may thus be more efficient and/or a volume of the cavity enclosed by first section 146 may thus be advantageously reduced.

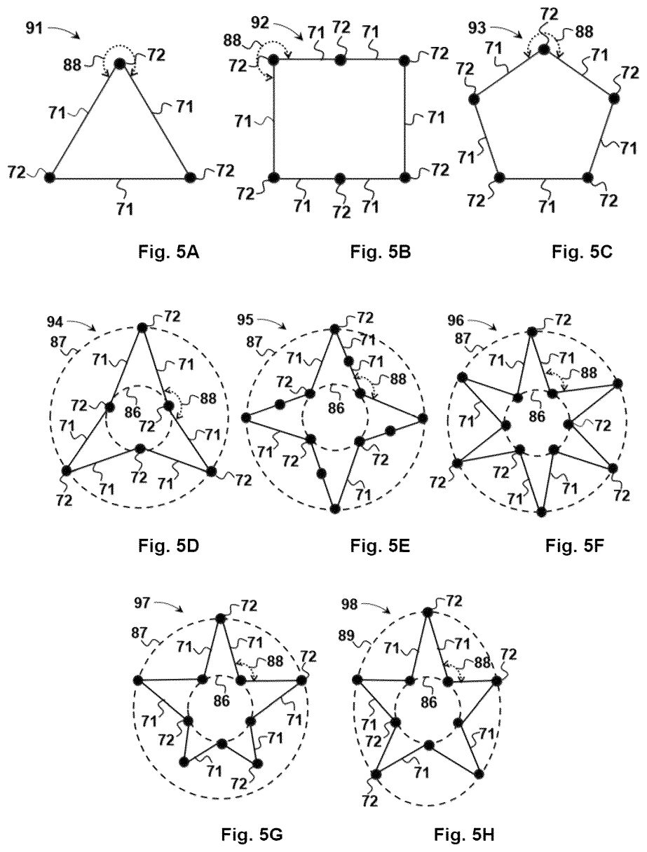

FIGS. 5A-5F schematically illustrate, in a cross sectional view, exemplary implementations of a section 91-98 of structure 18, 61, 111, 121, 131, 141 of mechanical element 12, 62, 112, 122, 132, 142 in which thinner portions 71 and thicker portions 72 are alternatingly arranged around an axis, in particular around a circumference of section 91-98. For instance, section 91-98 may be implemented as first section 66, or the membrane section, of structure 61. As illustrated, section 91-98 of structure 18, 61 comprises edges joined at corners, wherein the edges are provided as thinner portions 71 and the corners are provided as thicker portions 72. In some implementations, as illustrated in FIGS. 5B and 5E, one or more thicker portions 72 may also be provided at one or more edges. In particular, each of thicker portions 72 is arranged between two of thinner portions 71. In particular, each of thicker portions 72 is protruding at an inner and/or outer surface of section 91-98 of structure 18, 61.

In the illustrated examples, section 91-98 of structure 18, 61 has a cross section approximating a polygon. Sections 91-93 illustrated in FIGS. 5A-5C are shaped as a convex polygon. In particular, section 91 illustrated in FIG. 5A has a triangular cross section. An angle 88 spanned between two of thinner portions 71 neighbouring each other, in particular two of thinner portions 71 joined by one thicker portion 72 arranged in between, at an outer surface of the circumference of section 91 is larger than 270°. Section 92 illustrated in FIG. 4B has a rectangular cross section. Accordingly, angle 88 spanned between two neighboring thinner portions 71 at the circumference is 270°. Section 93 illustrated in FIG. 5C has a cross section of a pentagon. Accordingly, angle 88 spanned between two neighboring thinner portions 71 at the circumference is at most 240°.

Sections 94-98 illustrated in FIGS. 5A-5C are shaped as a concave polygon. Such a shape of section 94-98 of the structure may be exploited to minimize a volume of the cavity enclosed by the structure and to maximize a surface of a circumference along which thinner portions 71 and thicker portions 72 are alternatingly arranged. In particular, section 94-98 of structure 18, 61 has a cross section touching an outer tangent curve 87, 89 of a larger radius at which at least two of thicker portions 72 are located and an inner tangent curve 86 of a smaller radius at which at least two other of thicker portions 72 are located, wherein at least two of thinner portions 71 extend between outer tangent curve 87, 89 and inner tangent curve 86. In some examples, as illustrated, outer tangent curve 87, 89 and/or inner tangent curve 86 is elliptical. In particular, as illustrated in FIGS. 5D-5G, outer tangent curve 87, 89 and inner tangent curve 86 may be circular. In the example illustrated in FIG. 5H, only inner tangent curve 86 is circular, wherein outer tangent curve 87, 89 is an ellipse surrounding two focal points.

Sections 94-98 have a cross section with a plurality of radial projections, wherein each of the projections comprises at least two thinner portions 71. In particular, sections 94-96 have a star shaped cross section comprising a plurality of circularly arranged projections, in particular jags or lugs or ledges, wherein each jag or lug comprises two thinner portions 71 joined at a radially outer edge formed by a thicker portion 72. Section 94 illustrated in FIG. 5D has a star-shape with three projections. Two thinner portions 71 which are joined by a thicker portion 72 located at inner tangent curve 86 span angle 88 at an outer surface of the circumference of at most 120°. Section 95 illustrated in FIG. 5E has a star-shape with four projections. Two thinner portions 71 which are joined by a thicker portion 72 located at inner tangent curve 86 span angle 88 of at most 90°. Section 96 illustrated in FIG. 5F has a star-shape with six projections. Two thinner portions 71 which are joined by a thicker portion 72 located at inner tangent curve 86 span angle 88 of at most 60°. Section 97 illustrated in FIG. 5G has a star-shape with five projections. Two thinner portions 71 which are joined by a thicker portion 72 located at inner tangent curve 86 span angle 88 of at most 72°. In the illustrated example, one or more of thicker portions 72 are positioned at a distance from tangent curves 86, 87, 89, in particular outer tangent curve 87, 89. In the other illustrated examples of Sections 94-96, 98, all thicker portions 72 are positioned on tangent curves 86, 87, 89. Section 98 illustrated in FIG. 5H has another star-shape with five projections.

Thinner portions 71 may each be defined as a portion, in particular a congruent portion, of the structure not exceeding, i.e. falling below or being equal, a thickness limit. Thus, thinner portion 71 may be thinner than the thickness limit at any location of the structure over which thinner portion 71 extends. Thicker portion 72, e.g., a thicker portion adjoining the thinner portion 71, may be defined as a portion exceeding, i.e. not falling below and not being equal, the thickness limit. Thus, thicker portion 72 may be thicker than the thickness limit at any location of the structure over which thicker portion 72 extends. A transition region between thinner portion 71 and thicker portion 72 may be defined as a region at which a thickness of the structure changes from being thinner to being thicker than the thickness limit. Neighboring thinner portions 71 may be defined as two portions not exceeding the thickness limit, wherein a thicker portion 72 exceeding the thickness limit is arranged in between.

To illustrate, the thickness limit may be selected as a value of 0.15 mm or smaller. Thus, when the thickness limit is selected as a value of 0.14 mm, thinner portion 71 can be defined as portion having a thickness not exceeding 0.14 mm, and thicker portion 72 can be defined as portion having a thickness exceeding 0.14 mm. A transition region between thinner portion 71 and thicker portion 72 can then be defined as a region at which a thickness of the structure changes from below 0.14 mm to above 0.14 mm. When the thickness limit is selected as a value of 0.1 mm, thinner portion 71 can be defined as portion having a thickness not exceeding 0.1 mm, and thicker portion 72 can be defined as portion having a thickness exceeding 0.1 mm. A transition region between thinner portion 71 and thicker portion 72 can then be defined as a region at which a thickness of the structure changes from below 0.1 mm to above 0.1 mm.

In particular, one or more of thinner portions 71 may have a homogeneous, e.g., constant, thickness not exceeding the thickness limit and/or one or more of thinner portions 71 may have a varying, e.g., increasing and/or decreasing, thickness not exceeding the thickness limit. Correspondingly, one or more of thicker portions 72 may have a homogeneous, e.g., constant, thickness exceeding the thickness limit and/or one or more of thicker portions 72 may have a varying e.g., increasing and/or decreasing, thickness exceeding the thickness limit. The thickness limit of at least two thinner portions 71 may be selected to be equal or different. Correspondingly, the thickness limit of at least two thicker portions 72, e.g., thicker portions 72 each adjoining different thinner portions 71, may be selected to be equal or different.

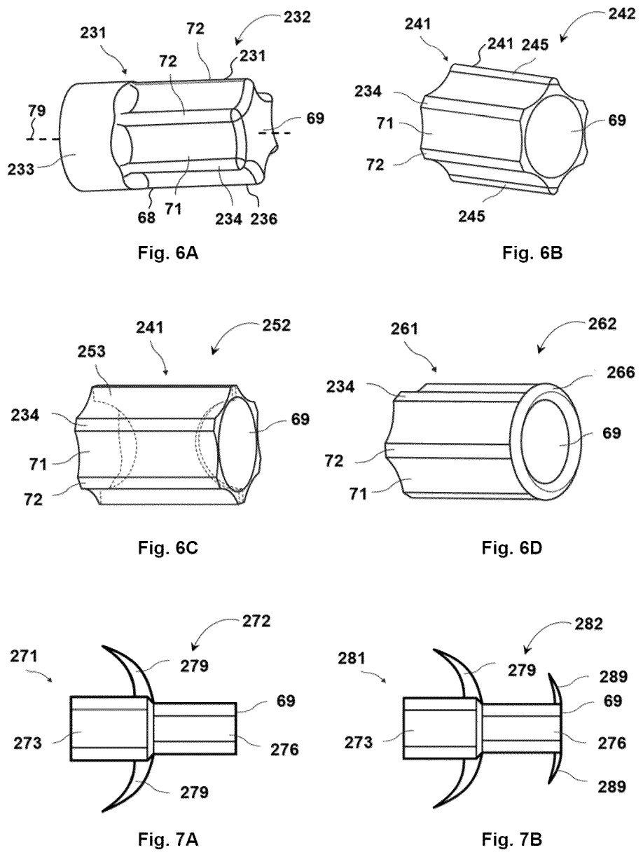

FIGS. 6A-6D schematically illustrate further exemplary mechanical elements 232, 242, 252, 262 configured to be connected to SD part 20, 50, 100, 120. Mechanical elements 232, 242, 252, 262 comprise a structure 231, 241, 261 with thinner portions 71 and thicker portions 72 alternatingly arranged around axis 79 of structure 231, 241, 261. Structure 231, 241, 261 has a cross section shaped as a convex polygon, in particular a hexagon, with edges joined as corners, wherein the corners are formed by thicker portions 72 and the edges comprise thinner portions 71. In the illustrated example, thinner portions 71 are curved. In particular, thinner portions 71 have a concave curvature at an outer surface of structure 231, 241, 261.

Mechanical element 232 illustrated in FIG. 6A comprises a first section 236 with thinner portions 71 and thicker portions 72 alternatingly arranged around axis 79, and a second section 233 constituting a mounting section to a sound tube and/or an electroacoustic transducer. Mechanical element 232, which includes front wall 69 and lateral wall 68 surrounding longitudinal axis 79, is shaped similar to a cup or beaker. Thicker portions 72 constitute stiffeners 234, in particular fins, spaced from one another along a circumference of lateral wall 68. Fins 234 are uniformly distributed around a circumference of lateral wall 68. E.g., the resulting shape may be similar to a hexalobular external key (e.g. Torx™). Fins 234 improve mechanical stability while thinner portions 71 may predominantly provide for the acoustic performance.

Mechanical element 242 illustrated in FIG. 6B comprises a structure 241 constituted by section 236 described above. A respective reinforcement part 245 is arranged on two opposite ones of the fins 234 in the shape of an additional rib on the fins 234. The reinforcement part 245 is configured to provide mechanical stability without impact on the acoustic performance. Reinforcement parts 245 on the outer surface of structure 241 may be easily added in a manufacturing process of mechanical element 242, but they increase the overall size of element 242.

Mechanical element 252 illustrated in FIG. 6C comprises structure 241 described above, wherein a reinforcement part 253 is arranged within the cavity enclosed by structure 241 to internally support two opposite ones of fins 234. The reinforcement part 253 may be configured as a planar structure extending between the two supported fins 234. In an exemplary embodiment, a planar structure of reinforcement part 253 may be based on a rectangular shape with a cut-out, e.g. a circular sector, in particular a half circle, cut out respectively on two opposing sides, one facing front wall 69 and the other facing opening 63 of structure 241 opposing front wall 69. Reinforcement part 253 is configured to provide mechanical stability without impact on the acoustic performance. The cut-out serves for providing an equal acoustic pressure at different positions inside the cavity. The cut-out does not necessarily have to be circular. Reinforcement part 253 on the inside, as illustrated, may support mainly along one dimension. In other examples, elements providing support in more directions are also conceivable. Reinforcement part 253 may be made out of a different material than structure 241 and inserted in a separate step. In some examples, the electroacoustic transducer and/or sound tube may extend into the cavity, wherein a portion of the electroacoustic transducer and/or the sound tube extending into the cavity may constitute the reinforcement part to internally support the structure.

Mechanical element 262 illustrated in FIG. 6D comprises a structure 261 having front wall 69 provided with a rounded portion 266 to prevent irritations in case of contact with the ear canal skin. Rounded portion 266 may be arranged circumferentially around a perimeter of front wall 69.

FIGS. 7A, 7B schematically illustrate further exemplary mechanical elements 272, 282 configured to be connected to SD part 20, 50, 100, 120. Mechanical element 272, 282 comprises a structure 271, 281 with thinner portions 71 and thicker portions 72 alternatingly arranged around axis 79 of structure 271, 281. Structure 271, 281 comprises a first section 276, which may be implemented corresponding to first section 66, 116, 126, 146, 236 described above, and a second section 273 configured to mount mechanical element 272, 282 to SD part 20, 50, 100, 120. Structure 271 illustrated in FIG. 7A is provided with a sealing member 279, e.g., a dome, for sealing against the ear canal of the user. Sealing member 279 may be integrally formed with structure 271. As illustrated, sealing member 279 may be provided at second section 273, e.g., in proximity to first section 276 and/or in proximity to opening 63 and/or in between first section 276 and opening 63.

Structure 281 illustrated in FIG. 7B is provided, in addition to sealing member 279, with a further sealing member 289, e.g., a further dome. Sealing member 289 may also be integrally formed with structure 281. As illustrated, sealing member 289 may be provided at first section 276, e.g., in proximity to front end 69 and/or between front end 69 and a transition portion between first section 276 and second section 273. Sealing member 289 may be implemented as an open sealing, e.g., an open dome, to maintain a desired functionality. An open dome is a dome with a relatively large acoustically open cross-section. This implies that a large amount of direct sound can enter through the sealing. For instance, sealing member 289 may be provided with one or more venting channels.

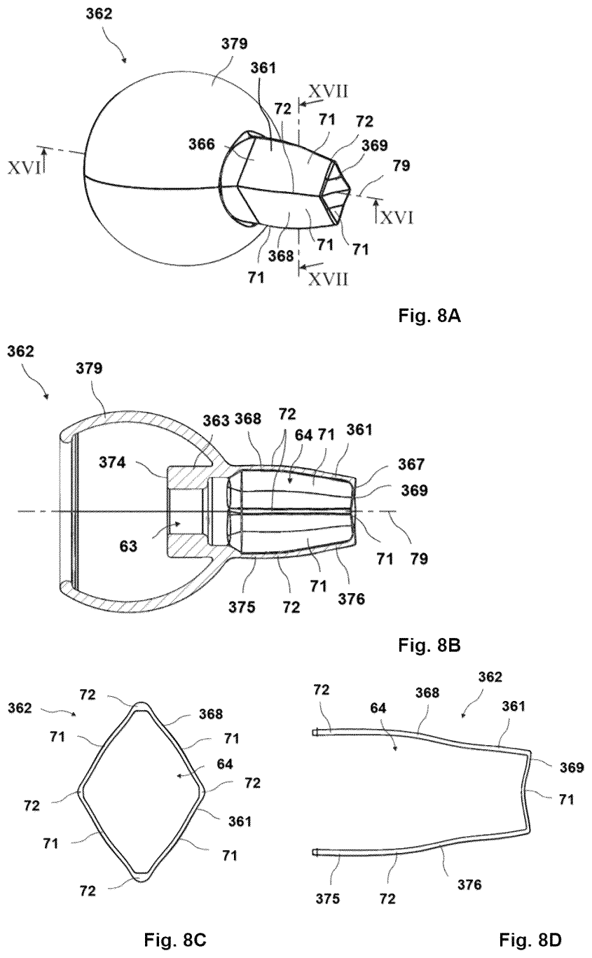

FIGS. 8A-8D illustrate a mechanical element 362 according to some embodiments of the present disclosure. FIG. 8A depicts element 362 in a perspective view, FIG. 8B in a longitudinal sectional view along a cutting plane XVI shown in FIG. 8A, FIG. 8C in a profile cross sectional view along a cutting plane XVII shown in FIG. 8A, and FIG. 8D in a profile longitudinal view along a cutting plane XVI. Element 362 comprises a structure 361 with a section 366 in which thinner portions 71 and thicker portions 72 are alternatingly arranged around axis 79 of structure 361, in particular along a circumference of structure 361.

Thinner portions 71 are angled relative to one another, in particular at an angle smaller than 180°. E.g., Thinner portions 71 may be associated with a respective virtual plane extending through a perimeter of the respective thinner portion 71, wherein respective normal vectors of the planes are angled relative to one another. Each of thinner portions 71 can thus be configured to vibrate in a different direction, e.g., in the direction of the normal vector, in order to transmit sound. In this way, an effective area of section 366, which is predominantly configured for sound transmission, can be effectively increased within a restricted space such as inside an ear canal, for instance as compared to a single flat-shaped membrane. E.g., structure 361 may include at least part of the thinner portions 71 in a polyhedric arrangement. An angle at which thinner portions 71 are angled relative to one another may be defined as an angle in between the respective virtual planes extending through the perimeter of the thinner portions 71.

In the illustrated example, a front wall 369 at a front end 367 of structure 361 is formed by thinner portion 71. In other examples, front wall 369 may comprise at least one thicker portion 72. Front end 367 is opposing a rear end 374 of structure 361 at which opening 63 is provided. A lateral wall 368 extends between front wall 369 at front end 367 and opening 63 at rear end 374. Lateral wall 368 comprises a plurality of thinner portions 71 surrounding cavity 64, e.g., as illustrated, four thinner portions 71. In particular, section 92 illustrated in FIG. 5B may be implemented in such a way. Front wall 369 and lateral wall 368 comprise an inner surface delimiting cavity 64 and an outer surface opposing the inner surface. The outer surface of the lateral wall 368 may define a lateral area of section 366. The outer surface of the front wall 369 may define a bottom of section 366. As illustrated, section 366 may have a cup-like or beaker-like shape with a bottom provided at front wall 369 and a lateral area provided at lateral wall 368.

Axis 79 extends through cavity 64 surrounded by lateral wall 368 between front end 369, at which front wall 369 is provided, and rear end 374, at which opening 363 is provided, e.g., between a center of opening 63 and a center of front wall 369. Cutting plane XVI extends through central axis 79. Central axis 79 is normal to cutting plane XVII. Lateral wall 368 further comprises thicker portions 72. At least part of the thicker portions 72 protrude from at least part of thinner portions 71 at the inner surface of lateral wall 368. In other examples, as described above, lateral wall 368 may also comprise thicker portions 72 protruding from at least part of thinner portions 71 at the outer surface of lateral wall 368.

Structure 361 further comprises, in addition to first section 366, a second section 363 of lateral wall 368. Second section 363 leads to opening 63 at rear end 374. Second section 363 is implemented as a mounting section. Structure 361 can thus be configured to be attached to the SD part 20, 50, 100, 120, e.g., the electroacoustic transducer and/or sound tube, by means of mounting section 363. A sealing member 379, implemented as a dome is integrally formed with structure 361. Sealing member 379 is attached to second section 363 at a distance from rear end 374.

A plurality of thicker portions 72 of lateral wall 368 extend between two thinner portions 71 respectively. Thicker portions 72 form stiffeners of section 366 by means of which a stiffness of structure 361 can be increased between thinner portions 71 due to the larger rigidity of stiffener 72. Stiffeners 72 may extend in parallel to axis 79 in the form of fins. Second section 363 may be thicker than stiffeners 72 to account for an increased stability required for the attachment to SD part 20, 50, 100, 120.

As illustrated in FIG. 8C, the thicker portions 72 protrude from thinner portions 71 at a region of the lateral wall 368 at which two respective thinner portions 71 are joined at an angle. The region of the lateral wall 368 at which the two thinner portions 71 are joined at the angle may constitute a corner region of the lateral wall 368, as illustrated. Thicker portions 72 can then be formed in at least part of the corner regions of the lateral wall 368. As further illustrated in FIG. 8C, a thickness of structure 361 progressively decreases at thicker portions 72 toward the adjoining thinner portions 71, in particular in a direction in which the thicker portions 72 lead to adjoining thinner portions 71. In some examples, also a thickness of the thinner portions 71 may vary. E.g., thinner portions 71 may become thicker toward thicker portions 72. In this way, a smooth transition between the thinner portions 71 and thicker portions 72 may be provided for. In other examples, thinner portions 71 and/or thicker portions 72 may be provided with a homogenous thickness.

As illustrated in FIGS. 8C and 8D, thinner portions 71 may have a curved shape. In particular, thinner portion 71 at front end 367 may comprises an inward curvature toward cavity 64. Thinner portions 71 of lateral wall 368 may comprise an outward curvature away from cavity 64. In this way, an effective area of structure 361 may be further increased.

As illustrated in FIGS. 8B and 8D, lateral wall 368 comprises a substantially cylindrical part 375 in which a cross section of lateral wall 368 remains constant, e.g., with regard to the direction of extension along longitudinal axis 79. Lateral wall 368 further comprises a conical part 376 in which a cross section of lateral wall 368 continuously decreases toward front end 369. Conical part 375 may facilitate insertion of mechanical element 362 into an ear canal and/or provide for an increased stability of structure 361 at a part of structure 361 which is more distant from the attachment to SD part 20, 50, 100, 120.

As illustrated in FIG. 8A, thinner portion 71 at front end 367 substantially extends perpendicular to thinner portions 71 of lateral wall 368. As illustrated in FIG. 8C, an angle spanned between two neighbouring thinner portions 71 of lateral wall 368 at an outer circumference of structure 361 is larger than 200®. In particular, the angle spanned between some of thinner portions 71 at the circumference of structure 361, as illustrated at the top and bottom of FIG. 8C, is smaller than 270°, and the angle spanned between some other of thinner portions 71 at the circumference, as illustrated at the left and right of FIG. 8C, is larger than 270°.

As illustrated in FIG. 8A, lateral wall 368 of structure 361 has a cross section approximating a polygon with edges joined at corners, wherein the corners are formed by thicker portions 72 and the edges comprise thinner portions 71. In particular, lateral wall 368 has a cross section approximating a rhombus with four corners formed by respective stiffeners, in particular fins, constituted by thicker portions 72. A diameter of lateral wall 368 across two opposing ones of corners 72 is greater than a diameter of the lateral wall 368 across the two other opposing corners 72. In the illustrated example, the edges between the corners 72, as formed by thinner portions 71, are slightly convex.

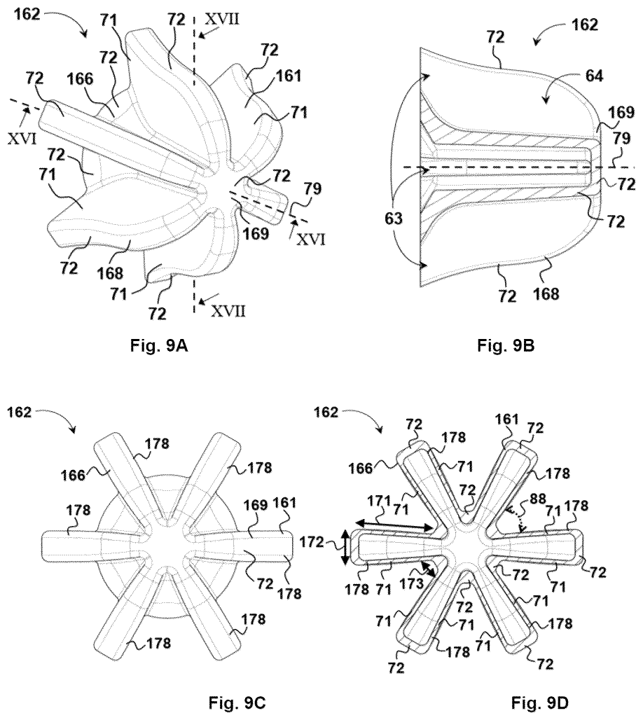

FIGS. 9A-9D illustrate a mechanical element 162 according to some embodiments of the present disclosure. FIG. 9A depicts element 162 in a perspective view, FIG. 9B in a longitudinal sectional view along a cutting plane XVI shown in FIG. 9A, FIG. 6C in a front view, and FIG. 9D in a cross sectional view along a cutting plane XVII shown in FIG. 9A. Element 162 comprises a structure 161 with a section 166 in which thinner portions 71 and thicker portions 72 are alternatingly arranged around a circumference of the structure 161. In some examples, as illustrated, element 162 consists of section 166. In other examples, as further described below, the element may comprise at least one additional section. For instance, first section 66 of structure 61 of mechanical element 62 illustrated in FIG. 2 may be implemented corresponding to section 166.

Structure 161 comprises a front wall 169 at a front end opposing a rear end at which opening 63 is provided. Structure 61 further comprises a lateral wall 168 surrounding cavity 64 and extending along central axis 79 between front wall 169 and opening 63. In the illustrated example, front wall 169 is implemented as a thicker portion 72. Structure 161 may be connected to SD part 20, 50 by an additional mounting means, e.g., a clamp or the like. In particular, the mounting means may comprise an opening having a shape corresponding to the shape of opening 63 to provide for an acoustical coupling of cavity 64 through opening 63 to electroacoustic transducer 17, 54 and/or sound tube 58 included in SD part 20, 50.

Structure 161 has a cross section with a plurality of radial projections 178 each comprising at least two thinner portions 71 joined by a radially outer thicker portion 72. Radial projections 178 are shaped as ledges, wherein thinner portions 71 extend substantially in parallel to one another. Outer thicker portions 72 are substantially flat. Each two neighbouring ledges 178 are joined by a radially inner thicker portion 72. In this way, ledges 178 are spaced from another at their radially inner end, wherein the distance between the ledges 178 increases toward their radially outer end. Thicker portions 72 form stiffeners of section 166 by means of which a stiffness of structure 161 can be increased between thinner portions 71 due to the larger rigidity of stiffener 72. Stiffeners 72 extend along axis 79 in the form of fins.

In the illustrated example, different projections 178 are equidistantly spaced from one another. Angle 88, which is spanned between opposing thinner portions 71 of neighboring projections 178, is at most 60°. In other examples, different projections 178 may have a different spacing. Ledges 178 are arranged around a circle forming a star shaped cross section of structure 61. In the illustrated example, six ledges 178 are circularly arranged. For instance, section 96 illustrated in FIG. 5F may be implemented as structure 161.

Thinner portions 71 have a width 171 between adjoining thicker portions 72. Radially outer thicker portions 72 have a width 172 between adjoining thinner portions 71. Radially inner thicker portions 72 have a width 173 between adjoining thinner portions 71. In the illustrated example, width 171 of thinner portions 71 exceeds width 172, 173 of adjoining thicker portions 72 by at least a factor of two.

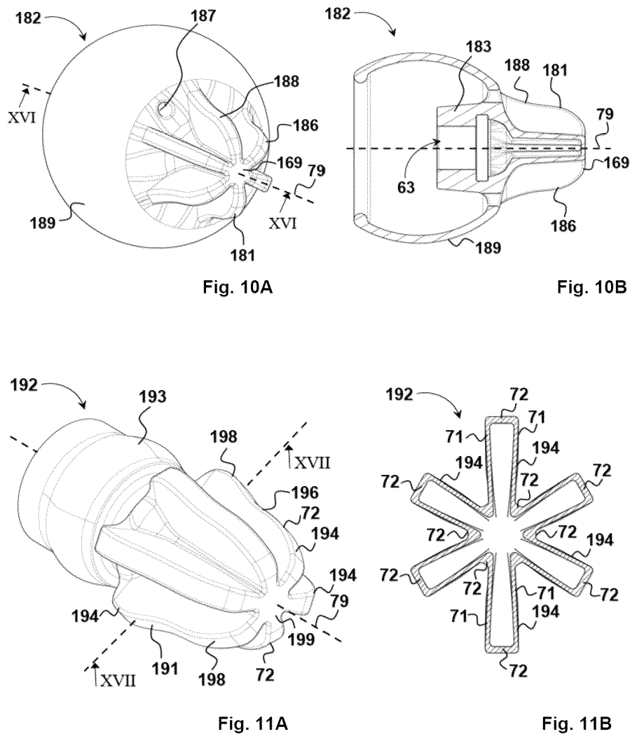

FIGS. 10A and 10B illustrate another mechanical element 182 according to some embodiments of the present disclosure. FIG. 10A depicts element 182 in a perspective view, and FIG. 10B in a longitudinal sectional view along a cutting plane XVI shown in FIG. 10A. Element 182 comprises a structure 181 with a first section 186 implemented corresponding to section 166 described above, and a second section 183. Structure 161 comprises front wall 169 at the front end opposing the rear end at which opening 63 is provided, and a lateral wall 188 surrounding cavity 64 and extending along central axis 79 between front wall 169 and opening 63. Second section 183 is a connector or mounting section for mounting mechanical element 62 to SD part 50, in particular electroacoustic transducer 57 and/or a sound tube. Lateral wall 188 comprises a thicker portion 183 at second section 183 in which at least part of electroacoustic transducer 57 and/or the sound tube is insertable. To this end, an inner surface of thicker portion 183 delimiting cavity 64 at opening 63 may have a shape corresponding to the shape of the portion of electroacoustic transducer 57 and/or sound tube 58.

Mechanical element 182 further comprises a sealing member 189 for providing an acoustical seal against the ear canal wall. Sealing member 189 can be integrally formed with mechanical element 182. To this end, sealing member 189 is formed at an outer circumference of lateral wall 188. E.g., as illustrated, sealing member 189 may be formed at second section 183, in particular at a front end of second section 183 at which second section 183 adjoins a rear end of first section. In this way, first section 186 can be effectively positioned inside the ear canal in front of the sealing provided by sealing member 189 to provide for sound transmission. Sealing member 189 is flexible to conform to varying ear canal sizes. In the illustrated example, sealing member 189 is implemented as a dome.

A venting channel 187 is implemented as a through hole in sealing member 189, e.g., at a position of the dome-like curvature of sealing member 189 which as facing the inner region of the ear canal and/or which is located in front of a position at which sealing member 189 provides for the acoustical seal. The venting channel can provide for a venting between the inner region of the ear canal and the ambient environment outside the ear canal when mechanical element 182 connected to SD part 20, 50 is at least partially inserted into the ear canal.

FIGS. 11A and 11B illustrate another mechanical element 192 according to some embodiments of the present disclosure. FIG. 11A depicts element 192 in a perspective view, and FIG. 11A in a profile cross sectional view along a cutting plane XVII shown in FIG. 11A. Element 192 comprises a structure 191 with a first section 196 in which thinner portions 71 and thicker portions 72 are alternatingly arranged around a circumference of the structure 161, and a second section 193 which is a connector or mounting section for mounting mechanical element 62 to an SD part. Structure 191 comprises a front wall 199 at a front end opposing the rear end at which opening 63 is provided, and a lateral wall 198 surrounding cavity 64 and extending along central axis 79 between front wall 199 and opening 63.

First section 196 has a cross section with a plurality of radial projections 194 each comprising at least two thinner portions 71 joined by a radially outer thicker portion 72 forming a star shape. Radial projections 194 are shaped as ledges. The cross section of first section 196 touches an outer tangent curve of a larger radius and an inner tangent curve 86 of a smaller radius, wherein the outer tangent curve is elliptical with two focal points, and the inner tangent curve is circular, similar to cross section 98 depicted in FIG. 5H. Accordingly, a radial length of different thinner portions 71 joined by radially outer thicker portions 72 and/or a radial length of different ledges 194 varies. In the illustrated example, six ledges 194 are circularly arranged in the star shape. Two of the ledges 194 opposing each other have a larger radial length than the four remaining ledges.

Radially outer thicker portions 72 are curved relative to central axis 79. The curvature decreases toward the front end at which front wall 199 is arranged. Correspondingly, a radial length of thinner portions 71 joined by radially outer thicker portions 72 and/or a radial length of ledges 194 decreases toward the front end. Correspondingly, lateral wall 198 tapers in first section 196 along central axis 79 toward the front end at which front wall 199 is provided.

In some implementations, mechanical element 192 may be connected to an electroacoustic transducer and/or a sound tube included in a custom shell to provide for an acoustical sealing. In some other implementations, mechanical element 192 may be directly connected to the custom shell, e.g., at an outer surface of the custom shell at which a sound outlet is provided. In some implementations, mechanical element 192 may be connected to an SD part including a sealing member to provide for the acoustical sealing.

FIGS. 12A-12C illustrate further mechanical elements 202, 212, 222 according to some embodiments of the present disclosure in a profile cross sectional view. Mechanical element 202 illustrated in FIG. 12A comprises a structure 201 in which four projections 204 are circularly arranged in a star-like manner, similar to circumference 95 illustrated in FIG. 5E. Angle 88 spanned by neighboring thinner portions 71 at an outer face of structure 201 is at most 90°. Projections 204 are substantially ledge-shaped, wherein a distance between opposing thinner portions 71 slightly decreases in a radial direction. In other examples, the mutual distance between opposing thinner portions 71 of the projections may decrease stronger, as schematically illustrated by the jags formed by thinner portions 71 in FIG. 5E. Mechanical element 212 illustrated in FIG. 12B comprises a structure 211 in which a star-shape is formed by seven projections 214. Angle 88 is at most 55°. A distance between opposing thinner portions 71 of projections 214 slightly increases in the radial direction. Mechanical element 222 illustrated in FIG. 12C comprises a structure 221 with a star-shape of eight projections 224. Angle 88 is 45° or less. A distance between opposing thinner portions 71 of projections 224 increases stronger in the radial direction as compared to projections 214 in FIG. 12B.

FIGS. 13A and 13B schematically illustrate one of thinner portions 71 during sound transmission. During sound transmission, thinner portions 71 can be excited to vibrate in a membrane like manner, e.g., similar to a substantially flat membrane. Different heights of a deflection of thinner portions 71 during the vibration are illustrated in FIGS. 13 and 13B as different contour lines 304. In the example illustrated in FIG. 13A, a maximum region of the membrane deflection 305 is shifted from the center toward a position at which a width of thinner portion 71 increases. This corresponds to a first vibrational mode of thinner portion 71. In the example illustrated in FIG. 13B, two maximum regions of the membrane deflection 315 are spaced from one another, e.g., about a half of a length of thinner portion 71. This corresponds to a second vibrational mode of thinner portion 71.

Generally, a mechanical and/or acoustic behavior of structures including thinner portions 71 in the above described way can be selected and/or tuned by a large number of parameters of thinner portions 71 including a thickness, shape, size, number of thinner portions 71, their geometrical arrangement relative to one another, and their position relative to the opening through which they are acoustically coupled to an electroacoustic transducer. E.g., thinner portions 71 can be configured to exhibit a modal behavior. A first vibrational mode is schematically illustrated in FIG. 9 by the single maximum height deflection 305. A second mode may exhibit two separate areas of a maximum height deflection. A resonance frequency of the different vibrational modes can thus be tuned by the various design parameters of thinner portions 71. To illustrate, a first mode may be tuned to be around 3 kHz, a second mode around 6 kHz, and a third mode above 7 kHz. Further, sharp resonances may be achieved when geometrical properties of multiple or all thinner portions 71 are equal. A flattening of the resonance peaks may be achieved by providing different geometrical properties of multiple or all thinner portions 71.

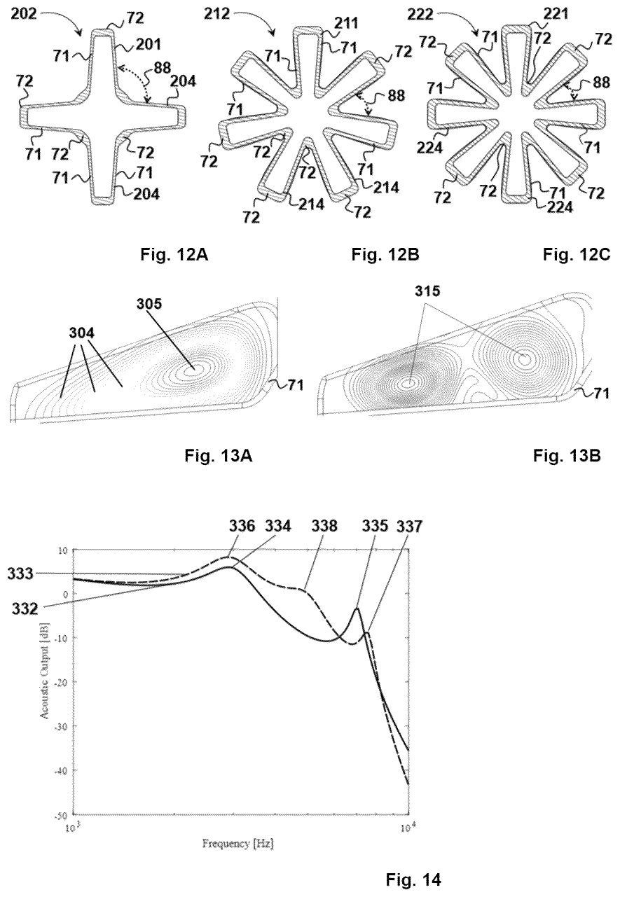

FIG. 14 illustrates a functional plot of an exemplary frequency response curve measurable in an inner region of an ear canal when a hearing device including an SD part is at least partially inserted into an ear canal. Alternatively, the frequency response may be measured, e.g., in a 2 cc coupling measurement system. A frequency of sound waves is horizontally indicated on an axis of abscissas. The frequency is indicated in units of Hertz. An acoustic output in units of decibel is vertically indicated on an axis of ordinates. A solid curve 333 represents the frequency response with mechanical element 12, 62, 162, 182, 192, 202, 212, 222 disconnected from the SD part. A dashed curve 333 represents the frequency response when the mechanical element is connected to the SD part.

As illustrated by solid curve 333, when the mechanical element is disconnected, a first resonance 334 be observed at about 3 kHz, and a second resonance 335 can be observed at about 7 kHz. As illustrated by solid curve 333, when the mechanical element is disconnected, a first resonance 336 is only slightly shifted to a lower frequency about 3 kHz, whereas a second resonance 337 is shifted more pronounced to a higher frequency of about 7.5 kHz. A broadening of all resonance peaks 336, 337 can be observed as compared to when the mechanical element is disconnected.

Further, a third resonance 338 can be observed at about 5 kHZ between first and second resonance 336, 337. Third resonance 338 has a broader peak as compared to resonances 336, 337 leading to an overall flattened frequency response curve between 2 and 6 kHz as compared to when the mechanical element is disconnected. In addition, the acoustic output can be increased in this frequency range as compared to when the mechanical element is disconnected. In addition, when the mechanical element is connected, a cutoff frequency above 8 kHz can be observed, lowering high frequency distortions, which may be attributed to the mechanical element acting as a low pass filter.

The advantageous frequency response illustrated in FIG. 14 can be obtained with a mechanical element in which section 66, 116, 126, 146, 166, 186, 196, 236, 366 of structure 61, 111, 121, 131, 141, 161, 181, 191, 201, 211, 221, 231, 241, 261, 361 is provided such that a volume of the enclosed cavity 64 is minimized and a circumference of the structure at which thinner portions 71 and thicker portions 72 are alternatingly arranged, in particular a surface of the circumference, is maximized. In some examples, those geometrical properties of the section of the structure may be achieved by a cross section of the structure with projections 168, 188, 198, 204, 214, 224 extending in the radial direction, in particular a star-shaped cross section, as provided, e.g., by structures 161, 181, 191, 201, 211, 221. More particularly, a structure including at least three projections, e.g., at least six projections 168, 188, 198, 204, 214, 224, in the radial direction may be employed to achieve a desired behaviour of the frequency response.

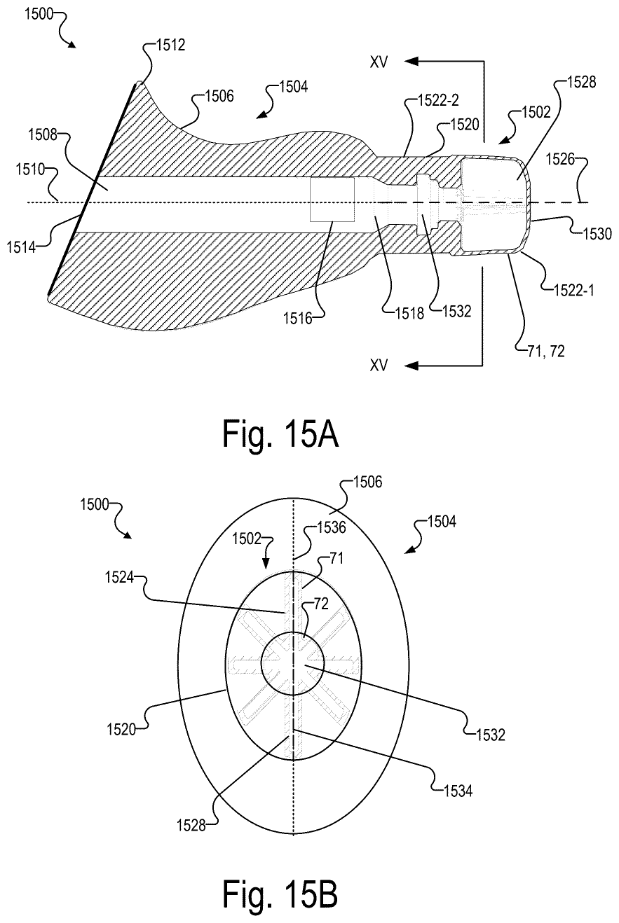

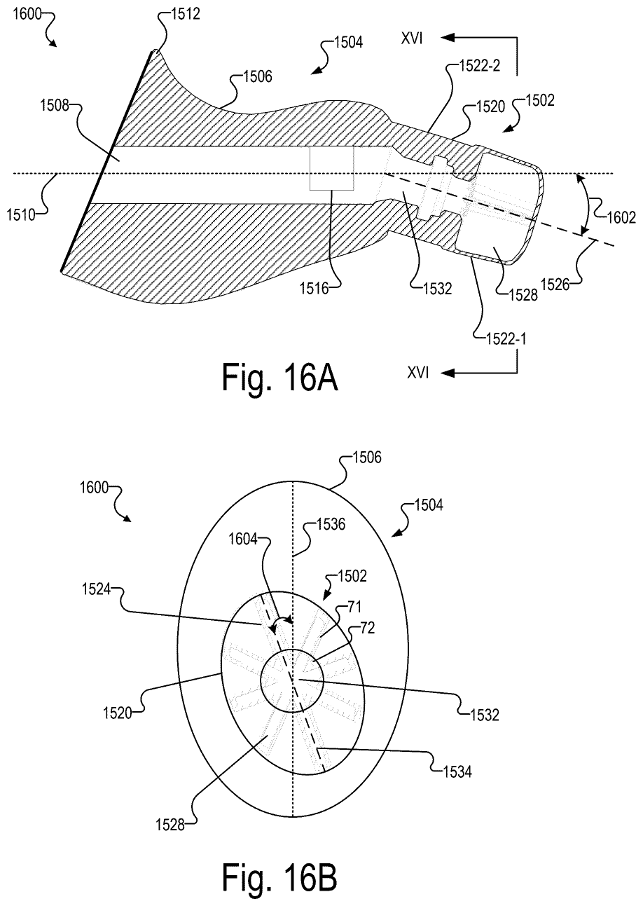

FIGS. 15A-15B schematically illustrate another exemplary ITE part 1500 comprising a mechanical element 1502 integrally formed with an SD part 1504. For example, FIG. 15A shows a side cross-sectional view of ITE part 1500 and FIG. 15B shows a cross-sectional view to ITE part 1500 taken along line XV-XV of FIG. 15A. Various components shown in FIGS. 15A-15B may be similar to and/or implement any one or more components of the ITE parts described above.

To illustrate, SD part 1504 may be similar to and/or implement SD part 20, 50, 100, 120. As shown, SD part 1504 comprises a custom shell 1506 that may be similar to and/or implement custom shell 105 in that custom shell 1506 has a shape at least partially customized to an ear canal (e.g., ear canal 80), in particular to the ear-canal of an individual user. Custom shell 1506 can thus constitute a sealing member forming an acoustical seal with an ear canal wall (e.g., ear canal wall 81). As illustrated, custom shell 1506 includes a sound tube 1508 extending therethrough, such as parallel relative to a longitudinal axis 1510 of custom shell 1506. Sound tube 1508 may be open at a rear end of custom shell 1506, which may also be referred to as a lateral end 1512. The opening may also be referred to as a lateral opening. The opening may be covered by a faceplate 1514 that may be similar to and/or implement faceplate 108 such that faceplate 1514 is mountable to lateral end 1512 of custom shell 1506 (e.g., to cover the lateral opening).

SD part 1504 further comprises an electroacoustic transducer 1516 that may be similar to and/or implement transducer 107. Transducer 1516 may be accommodated in an inner volume (e.g., sound tube 1508) enclosed by custom shell 1506. Sound tube 1508 of custom shell 1506 may further be open at a front end of custom shell 1506, which may also be referred to as a medial end. The opening may also be referred to as a medial opening 1518. Medial opening 1518 may allow sound sound generated by transducer 1516 and guided through sound tube 1508 to be delivered to mechanical element 1502.

Mechanical element 1502 may be similar to and/or implement any one or more components of mechanical elements 12, 62, 112, 122, 132, 142, 162, 182, 192, 202, 212, 222, 232, 242, 252, 272, 282, 362. For example, mechanical element 1502 may include a structure 1520 having a first section 1522-1 and a second section 1522-2. First section 1522-1 includes one or more thinner portions 71 and thicker portions 72 alternatingly arranged around a circumference of first section 1522-1. In the illustrated example, first section 1522-1 includes a plurality of radial projections 1524 extending outwardly about a longitudinal axis 1526 of structure 1520 (e.g., forming a star shape), the radial projections 1524 comprising thinner portions 71 and thicker portions 72. In the illustrated example, radial projections 1524 are hollow such as to form a cavity 1528 within first section 1522-1. In some implementations, radial projections 1524 lead to a front wall 1530 enclosing cavity 1528. Front wall 1530 may be implemented as a thinner portion 71 and/or a thicker portion 72.

First section 1522-1 of mechanical element 1502 is configured to transmit sound emitted by transducer 1516 from cavity 1528 to an exterior of mechanical element 1502, in particular to an inner region of the ear canal when ITE pat 1500 is inserted into the ear canal. In particular, a transmission of sound through first section 1522-1 may be more effective at thinner portions 71 and a rigidity of first section 1522-1 may be enhanced by thicker portions 72. To illustrate, thinner portions 71 may be predominantly employed to transmit sound and thicker portions 72 may predominantly provide for a different functionality, e.g., stabilizing the structure and/or maintaining a desired shape of first section 1522-1 of mechanical element 1502 also during sound transmission. In particular, thinner portions 71 may more easily be stimulated to vibrate during sound transmission, e.g., with a smaller mechanical damping and/or a larger vibration amplitude, as compared to thicker portions 72 due to a smaller mass of the thinner portions 71.

While first section 1522-1 is shown as having a star shape, first section 1522-1 of mechanical element 1502 may have any additional or alternative shape that may be adapted for different ear canal geometries, e.g. small or large ear canals or circular and elliptical ones. In some implementations, mechanical element 1502 can be combined together with a sealing member, e.g., a dome, into one single element.

Second section 1522-2 of structure 1520 integrally connects first section 1522-1 with custom shell 1506, e.g., at the position of medial opening 1518. Second section 1522-2 further comprises an opening 1532 extending therethrough from medial opening 1518 of SD part 1504 to cavity 1528 of first section 1522-1 along longitudinal axis 1526 of structure 1520. In this way, cavity 1528 enclosed by structure 1520 of mechanical element 1502 may be acoustically coupled to transducer 1516 through opening 1532. Accordingly, sound emitted by transducer 1516 may be delivered through medial opening 1518 of sound tube 1508, through opening 1532, to cavity 1528 of first section 1522-1 for transmission through mechanical element 1502. Second section 1522-2 may have a structure that is configured to maintain the position and/or orientation of first section 1522-1 relative to custom shell 1506.

In the illustrated example, second section 1522-2 is configured to align axis 1526 of structure 1520 to substantially overlap and/or be concentric with axis 1510 of sound tube 1508. Alternatively, second section 1522-2 may be configured to offset axis 1526 of structure 1520 relative to axis 1510 of sound tube 1508. Moreover, in the illustrated example, structure 1520 and custom shell 1506 each have an elliptical shape such that second section 1522-2 is configured to align a major axis 1534 of the elliptical shape of structure 1520 with a major axis 1536 of the elliptical shape of custom shell 1506 to substantially overlap. Still other suitable configurations and/or orientations for positioning mechanical element 1502 relative to SD part 1504 may be used.

As an illustrative example, FIGS. 16A-16B schematically illustrate another exemplary ITE part 1600 that may be similar to and/or implement ITE part 1500 in that ITE part 1600 comprises mechanical element 1502 integrally formed with SD part 1504. For example, FIG. 16A shows a side cross-sectional view of ITE part 1600 and FIG. 16B shows a cross-sectional view to ITE part 1600 taken along line XVI-XVI of FIG. 16A. However, as shown FIG. 16A, mechanical element 1502 is connected to SD part 1504 such that axis 1526 of structure 1520 is aligned at an angle 1602 relative to axis 1510 of sound tube 1508. Angle 1602 between axis 1526 of structure 1520 and axis 1510 of sound tube 1508 may be within 20°, e.g., 10°. Additionally or alternatively, axis 1526 of structure 1520 may be positioned at a distance from axis 1510 of sound tube 1508, e.g., shifted in parallel to axis 1510 of sound tube 1508. Accordingly, the orientation of axis 1526 of structure 1520 relative to axis 1510 of sound tube 1508 may be adapted based on a geometry of the ear canal of an individual user.

Additionally alternatively, as shown in FIG. 16B, mechanical element 1502 may be rotated relative to SD part 1504 about axis 1526 (e.g., clockwise or counterclockwise about axis 1526). In this way, a major axis 1534 of the elliptical shape of structure 1520 may be rotated and/or offset relative a major axis 1536 of the elliptical shape of custom shell 1506 at an angle 1604. Angle 1604 between major axis 1534 of structure 1520 and major axis 1536 of custom shell 1506 may be within plus or minus 90°. The orientation of major axis 1534 of structure 1520 relative to major axis 1536 of custom shell 1506 may be adapted based on a geometry of the ear canal of an individual user.

To fabricate an ITE part 1500, 1600 having a custom shell 1506, a user-specific ear canal geometry may be initially determined, e.g., by taking impressions of the user's ear canal. Subsequently, custom shell 1506 and structure 1520 may be formed by taking into account the predetermined individual ear canal geometry using a mold.

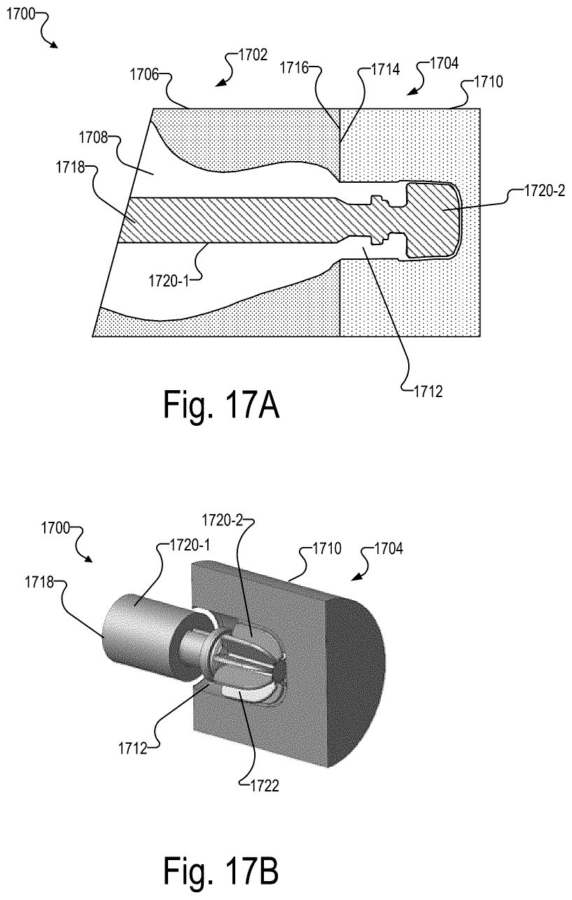

FIGS. 17A-17B schematically show an illustrative mold 1700 that may be used to form an ITE part 1500, 1600 having mechanical element 1502 integrally formed with SD part 1504. For example, FIG. 17A shows a side cross-sectional view of mold 1700 and FIG. 17B shows a perspective cross-sectional view of mold 1700 with a first portion 1702 of mold 1700 omitted for illustrative purposes.

As shown, mold 1700 comprises a first portion 1702 and a second portion 1704. First portion 1702 includes a first outer shell 1706 having a first interior 1708 shaped to form custom shell 1506 of SD part 1504. Accordingly, first interior 1708 may be formed based on the impressions of the individual ear canal such that first interior 1708 is customized for the individual ear canal (e.g., for forming custom shell 1506). In some examples, first outer shell 1706 of first portion 1702 is used to form an individual custom shell 1506 such that first outer shell 1706 is not reusable after forming the individual custom shell 1506. In some examples, first outer shell 1706 may be made from a resin material configured to be broken away and/or dissolved from the formed custom shell 1506. In some examples, first outer shell 1706 may be formed such as by 3D printing, e.g., in a resin-based 3D printing technology, such as digital light processing (DLP) or another stereolithography (SLA) process.

Second portion 1704 of mold 1700 includes a second outer shell 1710 having a second interior 1712 shaped to form structure 1520 of mechanical element 1502. Because structure 1520 of mechanical element 1502 may have a standard shape across different ITE parts 1500, 1600, second interior 1712 of second outer shell 1710 may have a standard shape that is associated with multiple ITE parts 1500, 1600. Such a standard shape may allow second outer shell 1710 to be reused for forming multiple ITE parts 1500, 1600. To illustrate, after being connected with a first outer shell 1706 to form a first mechanical element 1502 integrally with a first custom shell 1506, second outer shell 1710 of mold 1700 may be reconnected with another first outer shell 1706 such as to form another mechanical element 1502 integrally with another custom shell 1506 having a different shape. In some examples, second outer shell 1710 may be made from a reusable rigid material, such as metal and/or plastic (e.g., thermoplastic). In some examples, second outer shell 1710 may be formed such as by 3D printing, e.g., in a resin-based 3D printing technology, such as digital light processing (DLP) or another stereolithography (SLA) process.

In the illustrated example, a lateral end 1714 of second outer shell 1710 is positioned at a medial end 1716 of first outer shell 1706 such that first interior 1708 is connected with second interior 1712. In this way, mechanical element 1502 may be integrally formed with custom shell 1506 using mold 1700. For example, a material (e.g., silicone) may be introduced into first interior 1708 and second interior 1712 of mold 1700 to form mechanical element 1502 integrally with SD part 1504 in the same material. In the illustrated example, second outer shell 1710 is further aligned with first outer shell 1706 such as to align an axis 1526 of a structure 1520 to be formed within second outer shell 1710 with an axis 1510 of a sound tube 1508 to be formed within first outer shell 1706 (e.g., angle 1602 is about 0°). Alternatively, second outer shell 1710 may be offset and/or angled relative to first outer shell 1706 such as to offset an axis 1526 of a structure 1520 to be formed with an axis 1510 of a sound tube 1508 to be formed (e.g., angle 1602 is greater than about 0° and less than about 20°).

Moreover, in the illustrated example, second outer shell 1710 is further rotationally aligned with first outer shell 1706 such as to align a major axis 1534 of an elliptical shape of a structure 1520 to be formed within second outer shell 1710 with a major axis 1536 of an elliptical shape of custom shell 1506 to be formed within first outer shell 1706 (e.g., angle 1604 is about 0°). Alternatively, second outer shell 1710 may be rotated (e.g., clockwise or counterclockwise) relative to first outer shell 1706 such as to offset a major axis 1534 of an elliptical shape of a structure 1520 to be formed with a major axis 1536 of an elliptical shape of custom shell 1506 to be formed (e.g., angle 1604 is between about −90° and 90°).

In some examples, mold 1700 further comprises an insert 1718 that may be positioned within mold 1700 to extend through first interior 1708 and second interior 1712. In the illustrated example, insert 1718 includes a first section 1720-1 configured to form an inner shell of first portion 1702 of mold 1700. To illustrate, first section 1720-1 extends through first interior 1708 and is adapted to form sound tube 1508 of SD part 1504. Insert 1718 further includes a second section 1720-2 configured to form an inner shell of second portion 1704 of mold 1700. To illustrate, second section 1720-2 extends through second interior 1712 and is adapted to form opening 1532 and cavity 1528 of structure 1520. In the illustrated example, second section 1720-2 includes a plurality of fins 1722 extending outwardly about a circumference of second section 1720-2 such as to form radial projections 1524 of mechanical element 1502, though second section 1720-2 may have any suitable shape for forming mechanical elements 1502 having various geometries as described herein.

In some examples, insert 1718 of mold 1700 may have a standard shape such for forming sound tube 1508, opening 1532 and/or cavity 1528 for multiple ITE parts 1500, 1600. In such instances where insert 1718 has a standard shape, insert 1718 may be reused for forming multiple ITE parts 1500, 1600. In some examples, insert 1718 may be made from a reusable rigid material, such as metal and/or plastic (e.g., thermoplastic). In some examples, insert 1718 may be formed such as by 3D printing, e.g., in a resin-based 3D printing technology, such as digital light processing (DLP) or another stereolithography (SLA) process.

Alternatively, one or more components of insert 1718 may have a custom shape for forming sound tube 1508, opening 1532 and/or cavity 1528 for an individual ITE part 1500, 1600. For example, insert 1718 may have a custom shape in which second section 1720-2 is offset and/or rotated at an angle (e.g., angle 1602 and/or angle 1604) relative to first section 1720-1 such as to adapt the shape of one or more of sound tube 1508, opening 1532 and/or cavity 1528 to an individual ITE part 1500, 1600. In such instances where insert 1718 may have a custom shape, insert 1718 may be formed to have the custom shape. Additionally or alternatively, one or both sections 1720 of insert 1718 may be formed to have a standard shape, but are connected with each other at a desired offset and/or rotation to form a mechanical element 1502 having a desired offset and/or rotation relative to a SD part 1504.

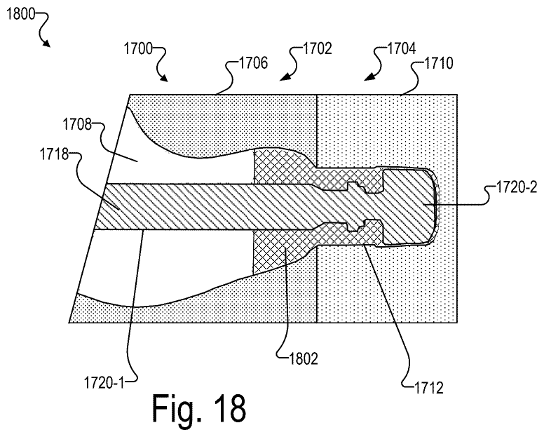

First portion 1702, second portion 1704, and/or insert 1718 of mold 1700 may be connected and/or held in place by any suitable connection (e.g., fasteners, guide pins, clamps, magnets, etc.). As an illustrative example, FIG. 18 schematically shows a cross-sectional view of another implementation 1800 of mold 1700 having a spacer 1802 positioned within mold 1700 such as to maintain an orientation and/or alignment of second portion 1704 of mold 1700 relative to first portion 1702 of mold 1700 as well as an orientation and/or alignment of insert 1718 relative to first portion 1702 and/or second portion 1704 of mold 1700. For example, spacer 1802 is positioned within at least a portion of second interior 1712 of second portion 1704 (e.g., between inner shell of second section 1720-2 and second outer shell 1710) and at least a portion of first interior 1708 of first portion 1702 (e.g., between inner shell of first section 1720-1 and first outer shell 1706). Spacer 1802 may thereby prevent rotation and/or an offset between first portion 1702 and second portion 1704 and/or between insert 1718 and first portion 1702 and/or second portion 1704.

In some examples, spacer 1802 is placed over insert 1718 such that first outer shell 1706 and/or second outer shell 1710 may then be placed over spacer 1802 (e.g., first outer shell 1706 and/or second outer shell 1710 may be formed by two or more parts that are positioned over spacer 1802 and insert 1718). In some examples, spacer 1802 is formed from a dissolvable material that may be configured to dissolve when a material for forming mechanical element 1502 and/or SD part 1504 is introduced into mold 1700. Still other suitable configurations for mold 1700 may be used.

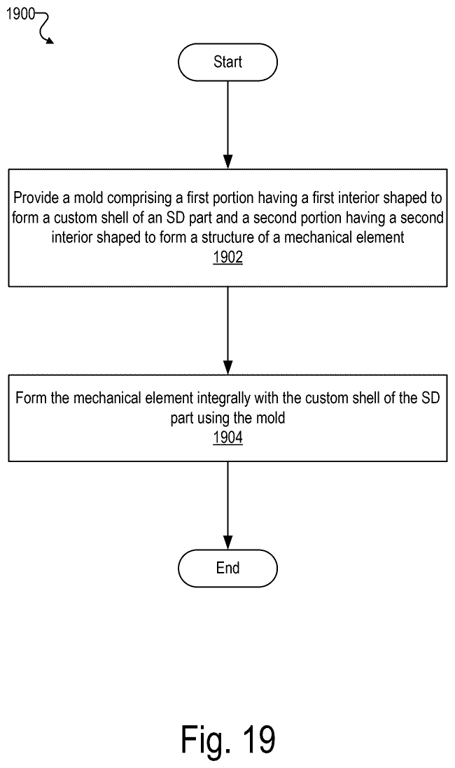

FIG. 19 shows an illustrative method 1900 for forming an ITE part 1500, 1600 using a mold 1700. While FIG. 19 illustrates exemplary operations according to one embodiment, other embodiments may omit, add to, reorder, and/or modify any of the operations shown in FIG. 19. Moreover, each of the operations depicted in FIG. 19 may be performed in any of the ways described herein.

As shown, method 1900 includes, at operation 1902, providing a mold 1700 comprising a first portion 1702 having a first interior 1708 shaped to form a custom shell 1506 of an SD part 1504 and a second portion 1704 having a second interior 1712 shaped to form a structure 1520 of a mechanical element 1502. For example, second portion 1704 of mold 1700 may be positioned at a medial end 1716 of first portion 1702 such that first interior 1708 is connected with second interior 1712. First portion 1702 and/or second portion 1704 may be formed such as by 3D printing, e.g., in a resin based 3D printing technology, such as digital light processing (DLP) or another stereolithography (SLA) process. First interior 1708 of first portion 1702 may be customized such as based on the impressions of the individual ear canal, while second interior 1712 of second portion 1704 may have a standard shape.

In some examples, at least second portion 1704 of mold 1700 comprises an inner shell (e.g., second section 1720-2 of insert 1718), an outer shell (e.g., second outer shell 1710), and a spacer 1802 positioned between the inner shell and the outer shell such that spacer 1802 is configured to align the inner shell with the outer shell (e.g., to prevent rotation of the inner shell within the outer shell). In some examples, spacer 1802 may additionally extend within at least a portion of first portion 1702 of mold 1700 such as to align an inner shell (e.g., first section 1720-1 of insert 1718) of first portion 1702 with an outer shell (e.g., first outer shell 1706) of first portion 1702 (e.g., to prevent rotation of the inner shell with the outer shell). Spacer 1802 may further align second portion 1704 of mold 1700 with first portion 1702 of mold 1700 such as a desired offset (e.g., angle 1602) and/or rotation (e.g., angle 1604). Spacer 1802 may further be configured to maintain the orientation of first portion 1702 relative to second portion 1704 such as by preventing rotation of second portion 1704 relative to first portion 1702.

Method 1900 further includes, at operation 1904, forming mechanical element 1502 integrally with custom shell 1506 of SD part 1504 using mold 1700. For example, mechanical element 1502 and custom shell 1506 may be cast such as by injecting first interior 1708 and second interior 1712 of mold 1700 with a material for forming mechanical element 1502 and custom shell 1506 (e.g., mechanical element 1502 and custom shell 1506 are formed with the same material, such as silicone). In instances where mold 1700 includes an insert 1718, the material may be provided between insert 1718 and first outer shell 1706 and second outer shell 1710 such as to form sound tube 1508, opening 1532, and/or cavity 1528 within mechanical element 1502 and/or SD part 1504. In instances where mold 1700 includes a spacer 1802, spacer 1802 may be configured to dissolve when the material is introduced into mold 1700.

After the material is introduced into mold 1700, the material within mold 1700 may be cured (e.g., for about 10 minutes, such as in a pressure over at about 80° C.). After curing, mechanical element 1502 and custom shell 1506 may be removed from mold 1700 such that mechanical element 1502 is integrally formed with custom shell 1506. In some examples, first portion 1702 of mold 1700 is broken away and/or dissolved from custom shell 1506, while second portion 1704 of mold 1700 may be removed from mechanical element 1502 such that second portion 1704 may be reused. For example, second portion 1704 of mold 1700 may be reused such as by connecting second portion 1704 of mold 1700 with another first portion 1702 and forming another mechanical element 1502 integrally with another custom shell 1506 having a different shape. Still other suitable methods for forming structure 1520 of mechanical element 1502 integrally with custom shell 1506 may be used. To illustrate, ITE parts 1500, 1600 may be formed by 3D printing a mechanical element 1502 integrally with a custom shell 1506.

While the principles of the disclosure have been described above in connection with specific devices and methods, it is to be clearly understood that this description is made only by way of example and not as limitation on the scope of the invention. The above described embodiments are intended to illustrate the principles of the invention, but not to limit the scope of the invention. Various other embodiments and modifications to those embodiments may be made by those skilled in the art without departing from the scope of the present invention that is solely defined by the claims. In the claims, the word “comprising” does not exclude other elements or steps, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

What is claimed is:

1. A hearing device configured to be worn at an ear of a user, the hearing device comprising:
a sound delivery (SD) part configured to be at least partially inserted into an ear canal, the SD part comprising a custom shell having a shape at least partially customized to the ear canal and an electroacoustic transducer housed within the custom shell; and
a mechanical element connected to a medial end of the custom shell of the SD part, the mechanical element comprising a structure enclosing a cavity with an opening facing the SD part such that the cavity is acoustically coupled to the electroacoustic transducer, wherein the structure comprises a section in which thinner portions and thicker portions are alternatingly arranged around an axis of the structure.

2. The hearing device of claim 1, wherein the structure of the mechanical element is standardized between multiple hearing devices.

3. The hearing device of claim 1, wherein the mechanical element is mountable to the medial end of the SD part.

4. The hearing device of claim 1, wherein the mechanical element is integrally formed with the medial end of the SD part.

5. The hearing device of claim 1, wherein the SD part comprises a sound tube having an axis in which direction sound is propagated, wherein the axis of the structure is aligned at an orientation that is within 20° relative to the axis of the sound tube when the mechanical element is connected to the SD part.

6. The hearing device of claim 5, wherein the orientation of the axis of the structure relative to the axis of the sound tube is adapted based on a geometry of the ear canal.

7. The hearing device of claim 5, wherein the structure is rotatable about the axis of the sound tube.

8. The hearing device of claim 7, wherein the rotation of the structure about the axis of the sound tube is adapted based on a geometry of the ear canal.

9. The hearing device of claim 1, wherein the thinner portions of the mechanical element are configured to transmit sound through the structure of the mechanical element.

10. The hearing device of claim 1, wherein a medial end of the mechanical element is closed.

11. The hearing device of claim 1, wherein the structure has a star-shaped cross section.

12. The hearing device of claim 1, wherein the structure has a cross section with a plurality of projections extending in a radial direction, wherein each of the projections comprises at least two thinner portions.

13. The hearing device of claim 1, wherein the thinner portions have a width between adjoining thicker portions, and the thicker portions have a width between adjoining thinner portions, wherein the width of at least one of the thinner portions exceeds the width of the adjoining thicker portions by at least a factor of two.

14. The hearing device of claim 1, further comprising a sealing member configured for sealing against an ear canal wall, wherein the sealing member is integrally formed with the element.

15. A hearing device configured to be worn at an ear of a user, the hearing device comprising:
a sound delivery (SD) part configured to be at least partially inserted into an ear canal, the SD part comprising a custom shell having a shape at least partially customized to the ear canal and an electroacoustic transducer housed within the custom shell; and
a mechanical element integrally formed with a medial end of the custom shell of the SD part, the mechanical element comprising a structure enclosing a cavity with an opening facing the SD part such that the cavity is acoustically coupled to the electroacoustic transducer, wherein the structure comprises a section in which thinner portions and thicker portions are alternatingly arranged around an axis of the structure.

16. A method of manufacturing a hearing device configured to be worn at an ear of a user, the hearing device comprising a sound delivery (SD) part configured to be at least partially inserted into an ear canal, the SD part comprising a custom shell having a shape at least partially customized to the ear canal and an electroacoustic transducer housed within the custom shell, and a mechanical element integrally formed with a medial end of the custom shell of the SD part, the mechanical element comprising a structure enclosing a cavity with an opening facing the SD part such that the cavity is acoustically coupled to the electroacoustic transducer, wherein the structure comprises a section in which thinner portions and thicker portions are alternatingly arranged around an axis of the structure, the method comprising:
providing a mold comprising a first portion having a first interior shaped to form the custom shell of the SD part and a second portion having a second interior shaped to form the structure of the mechanical element, the second portion positioned at a medial end of the first portion such that the first interior is connected with the second interior; and
forming the mechanical element integrally with the custom shell of the SD part using the mold.

17. The method of claim 16, further comprising reusing the second portion of the mold by connecting the second portion of the mold with another first portion and forming another mechanical element integrally with another custom shell having a different shape.

18. The method of claim 16, wherein the second portion of the mold comprises an inner shell, an outer shell, and a spacer positioned between the inner shell and the outer shell, the spacer configured to prevent rotation of the second portion relative to the first portion.

19. The method of claim 18, wherein the spacer is dissolvable.

20. The method of claim 16, wherein the second portion is aligned with the first portion such that an axis of the second portion is aligned within 20° relative to an axis of the first portion.
